(19) United States
(12) Patent Application Publication
(10) Pub. No.: US 2018/0035606 A1
(43) Pub. Date: Feb. 8, 2018

(54) Smart Interactive and Autonomous Robotic Property Maintenance Apparatus, System, and Method

(71) Applicant: Romello Burdoucci, Germantown, TN (US)

(72) Inventor: Romello Burdoucci, Germantown, TN (US)

(21) Appl. No.: 15/230,364

(22) Filed: Aug. 5, 2016

(51) Int. Cl. A01D 34/00; A01D 43/14; B25J 9/16; G05D 1/02; B64C 39/02; B08B 1/00; B08B 1/04; B08B 3/02; B08B 3/04; A01D 34/84; H04N 5/232

(52) U.S. Cl. CPC A01D 34/008; A01D 34/84; A01D 43/14; B25J 9/1697; G05D 1/0202; H04N 5/23293; B08B 1/002; B08B 1/04; B08B 3/026; B08B 3/04; B64C 39/024; B64C 2201/12; B64C 2201/027; B64C 2201/141; B64C 2201/146

(57) ABSTRACT

The present invention relates to an intelligent interactive apparatus, system and method that aligns with property trimming and cutting tools such as pole saws, lawnmowers or unmanned aerial drones. More particularly, the present invention relates to a pole saw or autonomous lawnmower with attached functional accessories such as autonomously operated line trimmer or lawn edging devices operating on a 360 degree axis obtaining power and motion on a electro magnetic levitation system and having an attached imaging apparatus assembly that is linked to a display output device allowing for more intelligent and consistent tree, grass, and hedge views and overall control. The tree trimming imaging apparatus assembly of the present invention allows for an intelligent interactive system wherein the method used makes a user capable of a more accurate and safe tree, hedge, or property trimming experience. The present invention's system is linked by superimposed design overlays giving augmented reality guidance, and an interactive imaging apparatus for an improved viewing method. The imaging device enables a more accurate tree, hedge or property grass trimming experience using an imaging and proximity sensors, and laser guided focal area that intelligently follows a grid mapping axis process using artificial intelligence algorithm and defect predictive analytics engine to reduce property maintenance trimming errors, safety risks, and difficulty.

### CROSS REFERENCED TO RELATED APPLICATIONS

This application claims the benefit of U.S. Provisional Application Nos. 62/182581 filed Jun. 21, 2015 and 62/201553 filed Aug. 5, 2015, and incorporated herein by reference in their entirety.

### BACKGROUND OF THE INVENTION

The present invention relates generally to a method, system, and apparatus for smart interactive and autonomous robotic property maintenance tools providing real time views of a targeted displaying views and superimposed design style overlays for trimming property assets to a desired state. The invention provides improved visual angels for a surface area plane, and optical sensory digital imaging processing while trimming, cleaning or cutting property assets that enables the user to also be instructed on the accuracy of cutting, trimming, or cleaning techniques using superimposed overlays, interactive augmented task actors, or voice prompted guidance interfaced with a camera 495, having an elongated high impact plastic material embodiment structure FIG. 8, an injection molded or metal stamped body FIG. 17 an injection molded unmanned aerial form FIG. 13 and a targeted cutting, trimming, or cleaning 550 tool as the preferred embodiment in order to achieve a desired property asset state. The invention 520 comprises a system, method, and apparatus for instructional guidance training in order to achieve a desired property asset state using autonomous guidance control system for overlay instructional training. Also, the present invention uses a predictive analytical analysis process of optically determining a change in property asset for comparing current state to future state's accuracy based on the superimposed design overlay to guide the user in order to achieve a desired property asset state. According to the present invention, operational control of a property maintenance asset tool using artificial intelligence neural network processing, and superimposed design styles overlays for cutting, trimming, or cleaning is embodied, which will allow a sensor to convert image processing to instruct the apparatus controller to operate further allowing the invention to automatically be controlled using microchip 610 embedded processor in order to achieve a desired property asset state. More specifically, this invention relates to the use of various embodiments of property maintenance tools, such as but not limited to autonomous lawnmowers having autonomously functioning line trimmer and edger property tools attached to a 360° degree rotational axis gyroscope gimbal, autonomously operated unmanned aerial drones having autonomously functioning saws, line trimmer, and edger property tools positioned on a gyroscope gimbal, and interactive pole saw with improved real-time views whereby more accurate cutting, trimming, edging, or cleaning of targeted property asset area is achieved. Also, the present invention embodies a robotic lawnmower capable of being guided by peer connected drones that canvas the target property based on geo-fencing restrictions indicated by the property owner or caretaker. According to the present invention, operational control can be user guided using bracket handles to maneuver the property identifying the property lines, obstructions, side walk and patio variances so the Artificial Intelligence machine learning engine grows in knowledge each subsequent owner guided correction or autonomous robotic lawnmower operation. The invention comprises a housing where a autonomously yet peer connected mesh network drone canvasses the target property and uses a fusion sensor array to identify additional obstructions, line variances between drive way and grass area, property privacy fence and autonomous lawnmower range and property maintenance's accuracy and relays any variances back to the cloud simultaneously communicating with other property devices the status of a particular zone being monitored thru a 3D topographical terrain depiction. More specifically the invention uses the sensor array comprising of proximity, image, sonar, laser distance, humidity, heat detection capability and shares this information with the mesh network nodes with real-time continuous data feeds that uses a mathematical algorithm to alter the geo-fenced property maintenance so the autonomous grass trimmer or edger device integrated with the robotic lawnmower knows the exact moment the device needs to reposition its gimbal pivoting head to perform its operational functions while the lawnmower mows the main yard at the same time. Also, the present invention uses a predictive analytical analysis machine learning process of optically determining a change in property variances and compares the accuracy of the property maintenance underway based on the superimposed design overlay to guide the autonomous property maintenance apparatus' system in order to achieve a desired property maintenance future design style state. According to the present invention, operational control of a property maintenance tools uses artificial intelligence, and superimposed guide styles overlays for property maintenance is explained, which will allow a sensor to convert image processing to instruct the apparatus' controller function to operate further allowing the invention to automatically be guided using embedded microchip processor in order to achieve a selected property maintenance future design style state. More specifically, this invention relates to the use of various types of property maintenance apparatus', such as but not limited to robotic lawnmowers with electro-magnetic power distributed and grass trimmers and edgers, geo-fenced autonomous drones using context aided sensor fusion for enhanced urban navigation with power cutting apparatus integrated for property maintenance, smart manual pump and battery operated wet and dry distribution streaming water gun like apparatus, autonomous robotic trash can positioning device whereby more accurate property maintenance of targeted area is achieved to stakeholders satisfaction.

### Description of Related Art

When a consumer purchases a property maintenance tool such as a pole saw, lawnmower, hedge trimmer; or lawn edger, the consumer is unaware of the complexities involved with manicuring their property assets personally; or whether a hired lawn worker has enough experience to trim the consumer's property assets to their desired state of exceptionally high quality. At home, the consumer must rely on their inexperience or limited available time to cut, clean, trim, or edge their property assets FIG. 5 or use a tool such as an inadequate pole saw FIG. 6 at odd and uncomfortable angles and heights to better perform the property asset maintenance to a preferred state of choiceness as a disadvantage shown in U.S. Pat. No. 7,152,328 and illustrated as prior art in FIG. 6. Referring now to example of prior art being U.S. Pat. No. 7,958,640 FIG. 5, a user is shown holding and using the present manual pole saw in dangerous and obviously less effective grip and high angled position. In FIG. 7, a user is shown holding a property maintenance pole saw tool and using it to trim tree branches that are dangerously near utility power lines. This presents a serious risk to the health and well-being of the user as well as possibly causing a utility power blackout if the saw blade cuts the powerline. U.S. Pat. 20010049039 refers to fuel cell stack integration. This invention overcomes the prior art by analyzing the operational efficiency grades the pattern recognition prediction methods used to optimize the fuel cell energy transfer transmission and storage of waste energy recycling thru an integrated active energy source while under operation as a source for recovery energy.

### U.S. Patents

| Patent Number | Description |
|---|---|
| 9,055,220 | Enabling the integration of a three hundred and sixty |
| | degree panoramic camera within a mobile device case |
| 9,052,896 | Adjusting mobile device state based on user intentions |
| | and/or identity |
| 9,052,885 | Using temperature margin to balance performance with |
| | power allocation |
| 9,052,752 | System and method for providing roll compensation |
| 9,044,861 | Robot |
| 9,043,953 | Lawn care robot |
| 9,043,952 | Lawn care robot |
| 9,031,779 | System and method for hazard detection and sharing |
| 9,030,495 | Augmented reality help |
| 9,030,419 | Touch and force user interface navigation |
| 9,030,407 | User gesture recognition |
| 9,030,382 | Method and device for target designation |
| 9,031,273 | Wearable computing device with behind-ear bone-conduction |
| | speaker |
| 9,026,299 | Navigation system and method for autonomous mower |
| 9,024,842 | Hand gestures to signify what is important |
| 9,024,772 | Multi sensor position and orientation measurement system |
| 9,022,999 | Fluid spraying apparatuses and related systems and methods |
| 9,021,777 | Cutter guard for a lawn mower |
| 9,020,638 | Position control method and robot |
| 9,019,508 | Fiber optic gyroscope arrangements and methods |
| 9,014,848 | Mobile robot system |
| 9,013,617 | Gyroscope conditioning and gyro-camera alignment |
| 9,004,973 | Remote-control flying copter and method |
| 8,989,922 | Modular drone and methods for use |
| 8,983,776 | Programmable robotic apparatus |
| 8,977,293 | Intuitive computing methods and systems |
| 8,966,806 | Apparatus and method for calculating aiming point |
| 8,958,654 | Method and apparatus for enhancing three-dimensional |
| | imagery data |
| 8,954,193 | Lawn care robot |
| 8,954,192 | Navigating autonomous coverage robots |
| 8,942,862 | Method and system for guiding a robotic garden tool to a |
| | predetermined position |
| 8,938,318 | Method and system for navigating a robotic garden tool |
| 8,937,591B2 | Systems and methods for counteracting a perceptual fading |
| | of a movable indicator |
| 8,933,876B2 | three dimensional user interface session control |
| 8,930,044 | Multi-part navigation process by an unmanned aerial |
| | vehicle for navigating to a medical situation |
| 8,886,384 | Lawn mower for forming images |
| 8,886,222 | Intuitive computing methods and systems |
| 8,796,885 | Combining power from multiple resonance magnetic |
| | receivers in resonance magnetic power system |
| 8,874,283 | Drone for inspection of enclosed space and method |
| | thereof |
| 8,874,264 | Celestial navigation system for an autonomous robot |
| 8,868,237 | Robot confinement |
| 8,862,431 | Method and apparatus for determining and retrieving |
| | positional information |
| 8,858,111 | Method & System of Quick Connector Assembly |
| 8,857,137 | Robotic lawn mower for cutting around conveyance member |
| 8,854,001 | Autonomous robot auto-docking and energy management |
| | systems and methods |
| 8,851,784 | System of An Extension Pole |
| 8,849,523 | Systems and methods for detecting soil characteristics |
| 8,838,274 | Method and system for multi-mode coverage for an |
| | autonomous robot |
| 8,812,284 | Highly representative real-time simulation of an avionics |
| 8,781,627 | Robot confinement |
| 8,780,542 | System and method for generating electricity from component |
| | waste heat |
| U.S. Pat. No. 8,770,022 | METHOD AND SYSTEM FOR DETERMINING NON- |
| | UNIFORMITY CHARACTERISTICS OF A VEHICLE TIRE |
| 8,749,196 | Autonomous robot auto-docking and energy management |
| | systems and methods |
| 8,731,295 | Visual segmentation of lawn grass |
| 8,725,316 | Robotic mower boundary sensing system |
| 8,715,133 | Rotary units, rotary mechanisms, and related applications |
| 8,707,569 | Quick Change Chain Saw System |
| 8,706,339 | Robotic mower boundary sensing system |
| 8,706,322 | Method and computer program product for controlling inertial |
| | attitude of an artificial satellite by applying gyroscopic |
| | precession to maintain the spin axis |
| 8,676,503 | System for determining and controlling inertial attitude, for |
| | navigation, and for pointing and/or tracking for an artificial |
| | satellite employing and optical sensor and a counter- |
| | rotational optical mirror, and terrestrial-based testing system |
| | for assessing inertial attitude functions of an artificial satellite |
| 8,666,554 | System and method for area coverage using sector |
| 8,666,550 | Autonomous cutting element for sculpting grass |
| 8,635,015 | Enhanced visual landmark for localization |
| 8,634,960 | Lawn care robot |
| 8,618,766 | Robot power source charging station |
| 8,600,662 | Method and system for plotting a user's position on a display |
| 8,600,553 | Coverage robot mobility |
| 8,584,305 | Modular robot |
| 8,549,826 | Robotic mower launch point system |
| 8,525,688 | Proximity Detection Alarm For An Inductively Charged Mobile |
| | Computing Device |
| 8,506,180 | Extendable camera support and stabilization apparatus |
| 8,485,330 | Communications spooler for a mobile robot |
| 8,478,442 | Obstacle following sensor scheme for a mobile robot |
| 8,473,187 | Method and apparatus for combining three-dimensional |
| | position and two-dimensional |
| 8,463,438 | Method and system for multi-mode coverage for an |
| | autonomous robot |
| 8,461,803 | Autonomous robot auto-docking and energy management |
| | systems and methods |
| 8,456,159 | Stabilization system for sensors on moving platforms |
| 8,439,449 | EZ Dump Lawn Vacuum |
| 8,433,468 | Robotic mower home finding system |
| 8,418,898 | Harness for power tool having a pole |
| 8,412,466 | Rapid method of pattern recognition, machine learning, and |
| 8,390,251 | Autonomous robot auto-docking and energy management |
| | systems |
| 8,374,721 | Robot system |
| 8,373,110 | System and method for linear and angular measurements of a |
| | moving object |
| 8,368,339 | Robot confinement |
| 8,364,309 | User-assisted robot navigation system |
| 8,359,142 | Varying irrigation scheduling based on height of vegetation |
| 8,352,113 | Robotic mower boundary coverage system |
| 8,336,282 | Robotic mower housing |
| 8,306,659 | Autonomous robot |
| 8,295,979 | Adaptive scheduling of a service robot |
| 8,275,506 | Boundary sensor |
| 8,234,848 | Robotic mower height of cut adjustment assembly |
| 8,234,010 | Tethered robot positioning |
| 8,191,268 | Reciprocating Pruning Saw |
| 8,156,655 | Pneumatically powered Pole Saw |
| 8,142,083 | Extendable Camera Support and Stabilization Apparatus |
| 8,136,333 | Lawnmower cutting deck and releasable blade |
| 8,132,759 | System and Method For Facilitating Aerial Refueling |
| 8,060,987 | Extension Pole with Docking Assembly for A Matching Tool |
| 8,024,995 | Systems and Methods of a power tool system with |
| | interchangeable functional attachments powered by a direct |
| 7,987,611 | Self Extending Elongate Member and Use Thereof |
| 7,980,510 | Small unmanned aircraft |
| 7,958,640 | Pole Saw Head Having A Rope Setting Auxillary Hook |
| 7,957,899 | Method for determining the attitude, position, and velocity of a |
| | mobile device |
| 7,913,345 | Systems and methods of a power tool system with |
| | interchangeable functional attachments |
| 7,840,355 | Accident avoidance systems and methods |
| 7,873,437 | Autonomous machine |
| 7,796,081 | Combined imaging and distance monitoring for vehicular |
| | applications |
| 7,787,989 | Method for controlling an autonomous mobile robot and |
| | related device |
| 7,743,683 | Systems and methods of a power tool system with |
| | interchangeable attachments powered by a direct rotational |
| 7,729,801 | Robot docking station and robot for use therewith |
| 7,720,366 | Actuator and lens unit and camera with the same |
| 7,663,333 | Method and system for multi-mode coverage for an |
| | autonomous robot |
| 7,599,758 | Sensors and associated methods for controlling a vacuum |
| 7,579,803 | Robot confinement |
| 7,567,052 | Robot navigation |
| 7,564,408 | Sensor network and method for monitoring a terrain |
| 7,538,715 | Electromagnetic location and display system and method |
| 7,532,541 | Object detection using acoustic imaging |
| 7,469,540 | Energy recovery from waste heat sources |
| 7,440,826 | Steering aid system for altitude and horizontal speed, |
| | perpendicular to the vertical, of an aircraft and aircraft |
| 7,429,843 | Method and system for multi-mode coverage for an |
| | autonomous robot |
| 7,424,766 | Sensors and associated methods for controlling a vacuum |
| 7,418,346 | Collision avoidance methods and systems |
| 7,377,162 | Method and apparatus for liquid level sensing |
| 7,374,130 | Method and apparatus for vehicle control using variable blade |
| 7,349,759 | Area coverage with an autonomous robot |
| 7,347,138 | Brew Chamber For A Single Serve Beverage Brewer |
| 7,318,493 | Hybrid Remote Control Lawn Mower |
| 7,239,944 | Programmable lawn mower |
| 7,165,488 | Brew Chamber For A Single Serve Beverage Brewer |
| 7,152,328 | Electric Pole Saw |
| 7,117,660 | Self-propelled lawn mower |
| 7,107,132 | Programmable lawn mower |
| 7,103,457 | Programmable lawn mower |
| 7,089,099 | Sensor Assemblies |
| 7,082,350 | Robot system |
| 7,069,111 | Method and system for controlling a robot |
| 7,066,291 | Robot system |
| 7,053,580 | Autonomous machine |
| 7,048,506 | Method and apparatus for magnetic actuation of variable |
| | pitch impeller blades |
| 6,994,575 | Desktop charger with adjustable connector module |
| 6,988,293 | Leaf Collection System For A Lawn Blower/Vacuum |
| 6,986,238 | Riding Lawnmower with attached weed trimmer |
| 6,984,952 | Navigation method and system for autonomous machines |
| | with markers defining the working area |
| 6,966,168 | Trimmer caddie for mower deck |
| 6,926,566 | Method and apparatus for synchronous impeller pitch vehicle |
| | control |
| 6,901,695 | Tree Limb Cutting and Trimming Tool |
| 6,885,912 | Area coverage with an autonomous robot |
| 6,879,878 | Method and system for controlling a robot |
| 6,850,024 | Navigation method and system for autonomous machines |
| | with markers defining the working area |
| 6,841,909 | Magnetic Drive System |
| 6,763,282 | Method and system for controlling a robot |
| 6,720,099 | Fuel cell waste energy recovery combustor |
| 6,690,796 | Rolling code security system |
| 6,686,951 | Crop row segmentation by K-means clustering for a vision |
| | guidance system |
| 6,650,975 | Multifunctional mobile appliance |
| 6,634,593 | Remote controlled aircraft, in particular for surveillance or |
| | inspection |
| 6,619,128 | Pressure gauge for toy water gun |
| 6,615,108 | Area coverage with an autonomous robot |
| 6,611,738 | Multifunctional mobile appliance |
| 6,604,348 | Mower with engine-driven blade and electrical propulsion |
| 6,600,981 | Multifunctional mobile appliance |
| 6,544,634 | Graphic image fusion |
| 6,519,143 | Docking Station |
| 6,502,017 | Multifunctional mobile appliance |
| 6,443,251 | Methods for stair climbing in a cluster-wheel vehicle |
| 6,427,944 | Systems and methods for using airborne communication |
| 6,400,996 | Adaptive pattern recognition based control system and |
| 6,385,515 | Trajectory path planner for a vision guidance system |
| 6,338,013 | Multifunctional mobile appliance |
| 6,321,515 | Self-propelled lawn mower |
| 6,278,918 | Region of interest selection for a vision guidance system |
| 6,275,773 | GPS vehicle collision avoidance warning and control |
| 6,255,793 | Navigation method and system for autonomous machines |
| | with markers defining the working area |
| 6,085,663 | System and method for magnetic levitation guideway |
| | emplacement on conventional railroad line installations |
| 6,082,247 | Apparatus for consecutively dispensing an equal volume of |
| 6,076,265 | Lawn mower having reciprocating cutter blade |
| 6,044,632 | Backup proximity sensor for a vehicle |
| 5,974,347 | Automated lawn mower |
| 5,916,111 | Self cleaning cutting head for mowers |
| 5,898,290 | Battery pack with capacity and pre-removal indicators |
| 5,840,189 | Beverage Filter Cartridge |
| 5,799,900 | Landing and take-off assembly for vertical take-off and |
| 5,740,987 | Helicopter cyclic control assembly |
| 5,686,810 | Charging Device |
| 5,638,574 | Convertible Leaf Blower and Vacuum |
| 5,367,836 | Automatic Drill Loader |
| 5,343,391 | Device for obtaining three dimensional contour data and for |
| | operating on a patient and related method |
| 5,325,765 | Beverage Filter Cartridge |
| 5,204,814 | Autonomous lawn mower |
| 5,203,302 | Overload warning apparatus for internal combustion engines |
| 5,050,771 | Repeatable pattern field spraying control |
| 4,989,400 | Disposable bag and mounting apparatus for a lawn mower |
| 4,962,462 | Fuel Cell Battery Hybrid System |
| 4,904,996 | Line-mounted, movable, power line monitoring system |
| 4,903,154 | Automatic diskette stack loader |
| 4,818,990 | Monitoring system for power lines and right-of-way using |
| | remotely piloted drone |
| 4,777,785 | Method of guiding a robotic lawnmower |
| 4,736,673 | Selective control device for plural kinds of oil-hydraulic |
| 4,706,848 | High efficiency battery operated water gun |
| 4,694,639 | Robotic lawn mower |
| 4,643,629 | Automatic loader |
| 4,442,753 | Carousel automatic ammunition loader system |
| 4,239,129 | Water pistol and or flashlight structure |
| 4,219,162 | Spray nozzles for spraying liquids |
| 4,218,827 | Gyroscopic aiming method and system for suspension |
| | system therefor |
| 4,142,379 | Waste energy recovery system |
| 4,087,919 | Rate integrating gyroscopic aiming method and device |
| 4,017,099 | Vehicle Leveling System |
| 3,951,510 | inertially stabilized heliostat assembly |
| 3,631,737 | Remote control manipulation for zero gravity environment |
| 3,446,980 | stabilized sight system employing auto collimation of gyro |
| 3,285,544 | Mid-Air Refueling System |
| 2,767,943 | Air to air refueling of fighter aircraft |
| 1,119,732 | Apparatus for transmitting electrical energy |
| US20140336781 | Hybrid augmented reality multimodal operation neural |
| US20100326031 | Weed line trimmer attachment for lawn mowers and method |
| | of attaching line trimmer to lawn mowers |
| US20040156699 A1 | Vertical rotary parking system |
| US20140254896 | Unmanned drone, robot system for delivering mail, goods, |
| | humanoid security |
| US20150085126 | Lawn Mower |
| US20130128043 | Lawn Mower |
| US20120211288 | Triangle track vehicle wheel |
| US20110216060 | Maintaining Multiple Views on A Shared stable virtual space |
| US20100288520 | Systems and methods of a power tool system with |
| | interchangeable power attachments |
| US20080161987 | Autonomous Vehicle Travel Control Systems and Methods |
| US20080161986 | Autonomous Vehicle Travel Control Systems and Methods |
| US20080147280 | Method and apparatus for sensing a rollover |
| US20080144944 | Neural network systems for vehicles |
| US20080140278 | Vehicle software upgrade techniques |
| US20070094195 | Artificial intelligence analysis, pattern recognition and |
| US20050035148 | Battery operated water gun with electronic power meter |
| US20050262842 | Process and device for the recovery of energy |
| US20100278523 | Extendable camera support and stabilization apparatus |
| S20010049039 | UFuel cell stack integrated with a waste energy recovery |
| US20090030605 | Positioning System |
| US20130187591 | Electric Vehicle Extended Range Hybrid Battery Pack System |
| US20130181511 | Electric Vehicle Extended Range Hybrid Battery Pack System |
| US20030136874 | Method For Safer Mid-Air Refueling |
| US20110068094 | High Energy Efficiency Electric Cooking System |
| US20130168171 | Ridden Vehicle With Hybrid Power System |
| US20130181511 | Electric Vehicle Extended Range Hybrid Battery Pack System |
| US20150039180 | Controller Apparatus and Sensors For vehicle door handle |
| US20150149035 | Moto vehicle with a control device for an extravehicular |
| | computer system |
| CN102545294 | Waste Electric Energy Recycling Device |
| CN202770037 | Waste Energy Recycling Device |
| WO2013165819A1 | An apparatus for recovering process exhaust energy |
| WO2016044793A1 | Apparatus and methods of waste energy recovery from a |
| | source of heated fluid |
| EP2974780A1 | Energy recovery for waste gas capture systems |
| D502,362 | Disposable Beverage Filter Cartridge |

### Foreign Patent Documents

| Foreign Doc. Nr. | Cntry Code | Kind Code | Pub. Dt |
|---|---|---|---|
| [symbol] | [symbol] | [symbol] | [symbol] |
| [symbol] | [symbol] | [symbol] | [symbol] |

[symbol]

indicates data missing or illegible when filed

### Nonpatent Literature Documents

Tesla To Launch EV Battery Swap Network. Edmonds.com. Jun. 21, 2013
Wireless Energy Transfer
A Locomotion Intent Prediction System Based on Multi-Sensor Fusion. Sensors.
2014, 14, 12349-12369; doi: 10.3390/s140712349
A More Efficient Engine. MIT Technology Review. 2007, MIT Laboratory for
Energy and the Environment
A Tiny Robotic Hand. MIT Technology Review. 2007. MIT Laboratory for Robotics
Easy and Simple Arduino Robot Arm. Autodesk. 2014
Energy Efficient Multipath Data Fusion Technique for Wireless Sensor Networks.
Network Security. 2012
The Benefits of a Good Electric Pole Saw. HubPags. 2014
Engine Efficiency. Wikipedia. 2015
Here's How Many People Have Registered Their Drones. Fortune.com, 2016
Minimum Energy Information Fusion in Sensor Networks. 1999, Lawrence
Lovermore National Laboratory
Apple Wins Patent for Inductive Charging Docking station. CNET. 2012
Apple Granted a Major Magnetic Resonance Power System Patent. Patently
Apple Reveals Master Details of Wireless Charging System. Patently Apple. 2013
Apples Wireless Charging Patent Might Actually Free Us From Wires. Wired. 2012
Close Encounters of a Drone Kind. R&D. 2015
This Pressure Cooker Generates Its Own. Reviewed.com, 2015
What is a gimbal -- and what does it have to do with NASA? HowStuffWorks.com,
Tesla To Launch EV Battery Swap Network. Edmunds.com, 2013
Decentralized Sensor Fusion for Ubiquitous Networking robotics in urban areas
Context-Aided Sensor Fusion for Enhanced Urban Navigation. MDPI. 2012.
A Radiosonde Using a Humidity Sensor Array with a Platinum Resistance Heater
and Multi-Sensor Data Fusion
Dynamic Reweighting of Three Modalities for Sensor
Nakamichi RX-505 Audio cassette deck with UniDirectional Auto Reverse
Wireless Communication The Comparative Study Between Broadcasting Satellite
Communication and Cellular Service
US20140254896 Unmanned drone, robot system for delivering mail, goods,
humanoid security

360 degree rotating attachments, so that the autonomously operated edger or grass trimmer for example is rotated on a axis to perform duties/tasks thereof such as edging the sidewalk simultaneously while the mower cuts the path of grass Smart debris/refuse door based on the path in which grass is being mowed so the exit door opposite of the path in which grass is being mowed is automatically opened and the other door is closed. Hyperspectral imaging, like other spectral imaging, collects and processes information from across the electromagnetic spectrum. The goal of hyperspectral imaging is to obtain the spectrum for each pixel in the image of a scene, with the purpose of finding objects, identifying materials, or detecting processes. Much as the human eye sees visible light in three bands (red, green, and blue), spectral imaging divides the spectrum into many more bands. This technique of dividing images into bands can be extended beyond the visible. In hyperspectral imaging, the recorded spectra have fine wavelength resolution and cover a wide range of wavelengths.

Engineers build hyperspectral sensors and processing systems for applications in astronomy, agriculture, biomedical imaging, geosciences, physics, and surveillance. Hyperspectral sensors look at objects using a vast portion of the electromagnetic spectrum. Certain objects leave unique ‘fingerprints’ in the electromagnetic spectrum. Known as spectral signatures, these ‘fingerprints’ enable identification of the materials that make up a scanned object. Manual pole cutter uses a pump action spring loader to allow user to build up energy enough to automatically drive the actuator in a reciprocal saw way Drone with hedge trimmer or tree limb saw can pivot on its axis to better reach targeted area Drones, pole saw, and lawn mower has multiple cameras to enable multiple views or simultaneous real-time feeds Automatic fuel dispenser using a self-locking apparatus similar to the way military planes refuel in mid air. Automatic power charging of electric drone or lawn mower, and offers quick battery exchanger for larger properties similar to how electric tesla car manufacture can replace batteries in cars while at convenience store U.S. Pat. No. 8,024,995 Systems and methods of a power tool system with interchangeable functional attachments powered by a direct rotational drive (has limitations and new invention overcomes these limitations via the use of attached camera and transmits images in the field of view to a display mobile device In alternative embodiment, the drone is capable of trimming hedges, bushes, or trees by encapsulating the target object, tilting, panning, or extending cutting platform to trim, top off, or taper the target object autonomously whether powered by electric battery or internal combustion engine, or advanced hover propulsion engine enabled. Alternative, the drone with power tool attachment functions as an autonomous gardener where the target object is designed with camera and uses augmented reality superimposed design based on the characteristics of the target object trimming needs. Alternatively, a camera cmos, sonic radar sensor, or non-threatening laser is used to determine the height or design trimming needs of the grass, tree, or hedge, or grass property to perform autonomous robotic edging. Alternatively, a manual using a clockwork system comprising a sliding shaft to tighten spring) or power pole saw is paired with a camera and a users mobile device using a video transmission cable or wireless technology to display the targeted trimming area on phone and provides augmented reality superimposed guides to assist the gardner in trimming the tree limbs. Alternatively, the camera, and phone is added as an enhancement to gutter or downsprout cleaner poles. Drone has mechanical retractable arm capable of placing light bulb in various size dimensions into lighting socket and securely snapping or screwing bulb into place autonomously or with the use of remote controlled device to enable stadium lights to be replaced, street lights, or security lights where the height above ground makes the task dangerous or too time consuming for human intervention. Targeted views can be displayed using augmented reality eye wear, smart screens, computing device, or projector glasses or mobile computing device. Images can be transmitted via wired or wireless connection to mobile device, holographic display, multi-dimensional display, augmented reality devices, smart technology wearables, remote device display. GPS analysis using point positional system Proximity Detection Alarm For An Inductively Charged Property Asset Maintenance Device. Inductively Charged Property Asset Maintenance Device Docking Station comprises the property maintenance. Exchangeable disposable cartridges filled with concentrated pesticide, insecticide, weed killer or other property maintenance products that is inserted manually or autonomously into a carriage to be mixed with water and sprayed autonomously onto certain areas of property to maintain control, and fed thru a tube into an attached functional accessory affixed to a 360 degree rotating axis that can also be attached to a attached water tank or self retracting flexible water hose mixing said concentrate to spray property asset for ideal maintenance. improved views for instructional design style selection with the image captured being transmitted using Bluetooth, RFID, dlna streaming, electrical Ethernet adapter, coaxial cable, USB, Ethernet cable, or wireless connection interface instructional cutting, trimming, edging, vanity design superimposed overlay patterns for property asset maintenance guidance grid superimposed overlay or augmented reality information feed used for the instructional property asset maintenance guidance drives the property asset tool's operational control, and user alerting training system. Magnetic levitation powertrain system having a cable attached to pulley system as alternate embodiment Floating by pass system so that accessory functional devices can pass by other accessories moving along the 360 degree rotational powertrain by exiting the main axis powertrain axis while maintaining power to tools. Neural ocular control function so tools can interactively communication and be controlled by mental thoughts of a secure user based on synaptic mind pulses. Smart refuse bin/ grass catcher on lawnmower where the module will independently return to main docking station and an elongated boom will vacuum grass or leaves from bin after being mulched. Smart fluidic line feeding system on grass trimmer head where camera monitors the line cutting swath while cutting grass and continuously computes radius to current state of line length. Upon measurement data analyzed, additional line is fed from the spool without an immediate need for user held version to tap the feeder to serve more line through the cutting head. Grass trimmer cutting line is fed thru guide loops that auto rotate around axis of line storage ar to reduce line sticking and help auto feed the cutting line. The guide loop can work in continuous motion or intermittent motion. Automated oil pan and oil filter changer comprises of an added apparatus of the autonomous tire changer with sensor enabled chocks that go behind rear tires to secure vehicle from rolling while tire change is occurring, to automated jack deployed using camera and sensor readings sent to mobile device, to armature being deployed to remove lug nuts and store re-tighten after change of tire using an improved Nakamichi Unidirectional Auto Reverse functionality for easily switches and changes tire. Laser targeting system with camera interface. Mini satellite web system with a drill bit in the middle that will cover the targeted screw with the mesh web and deploy the screw drill bit and once the screw becomes dislodged, the web shall catch the screw in order to reposition it right side up before storing in a cylindrical chamber for eventual redeployment. In one embodiment, a wheel assembly service system includes a rotatable spindle configured to receive a wheel assembly wherein the wheel assembly includes at least a rim and a tire. The system further includes a load device configured to apply a load to the tire during a rotation of the wheel assembly on the spindle, and a controller configured to determine a first force variation vector of the wheel assembly, prompt a user to rotate the tire with respect to the rim, determine a second force variation vector of the wheel assembly Improvement over existing pump and battery driven spray applicator container is to use the spring loaded to store energy capable of operating the spray applicator for a specified amount of time.

Autonomous rug and carpet shampooing apparatus with camera, color variance sensor, and proximity sensor. Steam cleaning device with hose and nozzle and a vapor producing chamber attached to a water source. Plug and play type autonomous memory system with modulated system design and device modulation to seamlessly combine lawnmower with well designed pop-out such as an autonomous edger. An alternative embodiment could be a tire changing system and device with autonomous chocks to autonomously deploy the chocks to go behind the rear wheels before the jack enables to change the tire. Modulated Auto morphing. In addition, there exit an improved invention in the embodiment of a power drill tool where different socket sizes such as ¾ inch, ⅝ inch, ¼ inch, types of tools like a hex tool etc are securely stored in a cylinder chamber resembling a six shooter gun, where a piston apparatus engages the particular sub tool using voice command, manual switch selection by user, eye tracking, Icd selection, or predictive analysis AI to automatically rotate the cylinder chamber to position the preferred tool within the chute before engaging the power train to operate the tool. It is an improvement where two tools can be engaged at one, led light and Philipps screw driver bit and camera transmitting views to users wearable like a smart watch, glasses or contacts, emerging mobile, or display technology. This improved technology allows for user to select a cylinder chamber with logical groupings of sub tools such as a chamber having 7 slots with varying sizes of ratchet sockets to use, and user can disengage the entire chamber and select a different size range of sub tools to engage by placing a newly selected larger sized ranged cylinder chamber to engage.

This invention overcomes those and many other disadvantages by using a camera apparatus 525 attached to the property maintenance tools' body as an attachment or hard wired FIG. 8 with integrated circuitry capable of capturing images of the targeted area the user desires to have cut; trimmed, mowed, or edged, and transmitting this visual information to a desired viewing apparatus for normal view 520, such as a preferred embodiment being a mobile device, augmented reality or eye retina projected glasses, or holographic or multi-dimensional display for convenience as shown in FIG. 9. The user can use the modified camera apparatus to send visual images as snap shots or real time streaming feeds to a display device 520 or other viewing device capable of receiving a transmission signal such as Wi-Fi, Bluetooth, DLNA, HDMI, electrical Ethernet adapter, coaxial cable, Cat45, Over-the-Air transmission, or USB cable. In an alternative embodiment, the camera 560 is hard wired FIG. 10 as part of the mobile device 550 enclosure or property asset maintenance device apparatus, and either the attached integrated circuit pole saw, hedge trimmer, lawnmower camera, or mobile device camera is capable of being operated using voice prompted operational commands. Alternatively, the camera device can be controlled using any relevant interface feature of the visual display devices. Once the targeted property asset area is captured by the camera device, the invention software superimposes an overlay of the preferred property asset maintenance state using an array of patterns to differentiate design maintenance area cutting ques 580 the user wants as shown in FIG. 11. This combined image can be viewed using any of the aforementioned viewing devices, so the user can gauge the accuracy of their property the targeted area correctly.

### BRIEF DESCRIPTION OF THE DRAWINGS

FIG. 1 is a process flow of preferred embodiment of the invention using normal operation and advanced interactive operational view with optional features of the present method and system invention comprising an image capture device, video display device, and features such as image stabilization sensor software, property overlay layers, image processing, profile setup actions

FIG. 2 is a process flow of alternative embodiment of the present invention using a image capture device integrated with an electric, battery or gas powered lawnmower operated with autonomous artificially intelligent engine and microprocessor for capturing targeted lawn maintenance area with invention comprising of autonomously operated line trimmer, lawn edger, hedge trimmer tools housed on a 360 degree rotational axis interfaced with system software also comprising of image processing system features software, image filtering, artificial intelligence, proximity sensor, laser targeting and guidance system, lighting and auto focus featured mobile application

FIG. 3 is a process flow of an alternative embodiment of the present invention where the system and method uses microchips, camera, laser scanning, and property grid pattern isolation to identify any anomalies or defects outside of the preferred property asset maintenance state; thereby creating smart appliances, that automatically allow for control of the operational functions of invention to cut, trim, or edge tool apparatus to maintain property asset

FIG. 4 is a process flow of an alternative embodiment of the present invention where the system and method uses microchips; thereby creating smart appliances, that automatically allow for control of the operational functions of invention preferred embodiment property asset tool apparatus

FIG. 5 is an image of a man attempting to cut a tree limb with a manual pole saw more than twenty-five (25) feet above ground level

FIG. 6 is an image of a man attempting to saw a tree limb more than fifteen (15) feet above ground level using an electric pole saw

FIG. 7 is an illustration of a man attempting to trim tree limbs with utility power lines nearby creating a dangerous possibility of being electrocuted

FIG. 8 is an image of the new invention of an electrically powered pole saw having multiple cameras attached and connected to a display device such as a user's mobile phone with camera views displayed on the display device. Alternatively, a pod canister and supply tube with spray nozzle can be attached to the apparatus to allow the user to manually or the apparatus can autonomously apply a spray foam to retard disease, insect infestation, or bacteria growth where the tree was recently cut. The foam can apparatus includes an adapter to work with various existing containers of spray material as well. The camera or spray nozzle can be on a fixed position or rotate on an axis using ball bearings or alternative would be magnetic levitation, or some other method known to those educated in such areas.

FIG. 9 is an image of a man using a gas powered pole saw to cut a tree limb using the improved invention with camera and phone displaying cameras' points of view

FIG. 10 is an image of a gas powered pole saw with the improved invention where cameras attached to the saw display images within the point of view of cameras onto mobile smart phone or alternative display apparatus

FIG. 11 is an image of a woman using the improved invention of the interactive battery-operated pole saw with cameras attached that transmit the point of view displays onto the attached mobile smart phone

FIG. 12 is an illustration of a remote controlled drone using a mobile smart device or controller wirelessly

FIG. 13 is an image of an autonomously operated or remote controlled unmanned aerial vehicle drone with a gimbal gyroscope and retractable control arm attached to a power saw for cutting tree limbs

FIG. 14 is an image of an autonomously operated unmanned aerial vehicle drone with a gimbal gyroscope and an attached power saw for trimming tree limbs

FIG. 15 is an image of an autonomously operated or remote controlled unmanned aerial vehicle drone with a gimbal gyroscope and retractable control arm attached to a power hedge trimmer

FIG. 16 is an image of an autonomously operated or remote controlled unmanned aerial vehicle drone with a gimbal gyroscope and an attached power hedge trimmer

FIG. 17 is an illustration of prior art where a user on a riding lawnmower which has an attachment with a grass trimmer manually operated by user (deficiency is that the this presents a dangerous situation because the user has to focus on steering the lawnmower which also maneuvering the grass trimmer in the other hand)

FIG. 18 is an image of an autonomously operated electric, battery, or hybrid powered grass mower with autonomously operated multi-function line trimming, tree saw, spray applicator, seed fertilizer spreader, hydraulic scissor and edger tools attached onto a 360 degree rotational axis with a grass receptacle attached in rear. Alternative embodiment would have a powertrain chassis scissor hydraulic lifting base to extend the range of the functional accessory tools operating on the magnetic levitation rotational axis to allow for hedge or bush trimming tool to operate. Alternatively, the apparatus can identify dog feces/pee or cow/pig or other livestock excrement in the field of view and using frozen air spray or insert rods to probe and release super cold solution that is bio-degradable or otherwise to solidify the feces and then extend a boom to vacuum or scoop the feces into a disposable bag or trailer container that is either pre loaded or automatically loaded and then deposited into a separate bin/area for discarding or composting

FIG. 19 is an illustration of a multi-functional powered interactive pole tool having an assortment of attachment options, multiple cameras, and mobile smart phone display device receiving transmitted camera images

FIG. 20 is an illustration of an autonomously operated and mechanically driven screw driver, screw loading, and retrieving device

FIG. 21 is an image of an example interactive pole attachment for removing and installing light bulbs with camera attachment for improved views of targeted camera view

FIG. 22 is an image of an example user having the interactive pole tool to clean house gutters with camera attached and images transmitted to smart mobile device for improved views to clean gutters more thoroughly

FIG. 23 is an illustration of an autonomously operated or remote controlled unmanned aerial vehicle drone with a gimbal gyroscope having cameras attached to trim property hedges or trees

FIG. 24 is an illustration of an autonomously operated or remote controlled unmanned aerial vehicle drone with a gimbal gyroscope cameras and having cutting panels capable of tilting, extending, retracting, or molding property hedges or trees with angled manipulation

FIG. 25 is an illustration of a hovering and autonomously operated or remote controlled unmanned aerial vehicle drone with a gimbal gyroscope balanced cutting panels capable of tilting, extending, retracting, or molding property hedges or trees with angled manipulation

FIG. 26 is an illustration of a grass and leaf vacuum attachment that gathers debris into net device to be autonomously bagged and discarded

FIG. 27 is an image of a lawn with superimposed grid pattern displayed based on predictive analytical engine

FIG. 28 is an image with color coding after defect analysis of terrain was initiated using artificial intelligence algorithm interfaced with camera

FIG. 29 is an image of the vanity designs that the invention can perform autonomously with the property asset

FIG. 30 is an image of an alternative embodiment of the invention where the cutting head is powered by energy stored in a pump or spring loading action by user

FIG. 31 is an illustration of a vertical rotary docking station and charging station bays, grass compacter with optional compost or pellet function with grass clippings used as raw material, outside hose pipe and filtering system, outside rain water capturing system connection to house gutters using flexible hose and filtering system depositing filtered water into storage tank of varying sizes options 100 gallon for example, hybrid solar electrical roof panel and AC connection to operate docking and charging methods. The apparatus also has a varying size optional autonomous gas filling station for devices that operate off of gas, as well as an exchangeable powertrain feature to use on e or more powertrains to navigate and use one or more modulated functional accessory bolt-on/snap ons (tesla battery exchange system, snap on tools, mechanical control harness and locking mechanisms) as part of the smart interactive and autonomous robotic property maintenance apparatus system method for property asset maintenance. In addition, a mini carwash/high pressure air or water jet function is enabled in the 1400 area where the blade, under carriage, engine and surface area of al returning apparatuses are cleaned with residue and debris flushing to a storage area directly below the docking pod which is carried to the mulching module to make pellets for fertilizing house plants or dropped into compost tea container where organic fertilizer tea is made to fertilize property assets. Electric generator for recovery when power outage occurs

FIG. 32 is an illustration of a smart interactive multi-product loader grass solution loader carousel for weed killer, fertilizer, mimicking the Kuereg instant coffee, but instead of coffee its various forms of lawn and garden solutions pesticide, insecticide, seed, feed, weed killer, ant killer, mole killer, etc

FIG. 33 is an image of a powertrain switching system used in conjunction with 360 degree axis for accessory functional tools to seamlessly pass by each other while operating to allow for various shapes and design configuration for optimal operational control of autonomous apparatuses while using a gimbal and gyroscope for multi-directional movement and balancing, which can also be incorporated into robotic property maintenance system deployed within bathroom wall, ceiling, or similar or deployed within vehicle seat head rest, along back of seat or in automobile roof to cut, trim, fashion a user's property autonomously

FIG. 34 is an image of the inventions smart grass trimmer head, with smart interactive multi-view camera system, smart proximity sensor, smart fluidic floating line feeding system

FIG. 35 is an illustration of the fluidic floating line feeding system with left and right floating handles with ports for fluidic line feeding process to overcome prior art inventions where the line would stick and fail to feed upon manual tap feed action from a user whereby the improved invention agitates the stored line so with advanced monitoring from smart camera automatically feeds additional line while trimmer is operational without the user have to take action using an alternative ratcheting using gearing ratio to cycle and increase line feed or process to click up or down certain levels to release additional line correlating to the rotational cyclical count of the trimmer head based on the Taylor Expansion formula

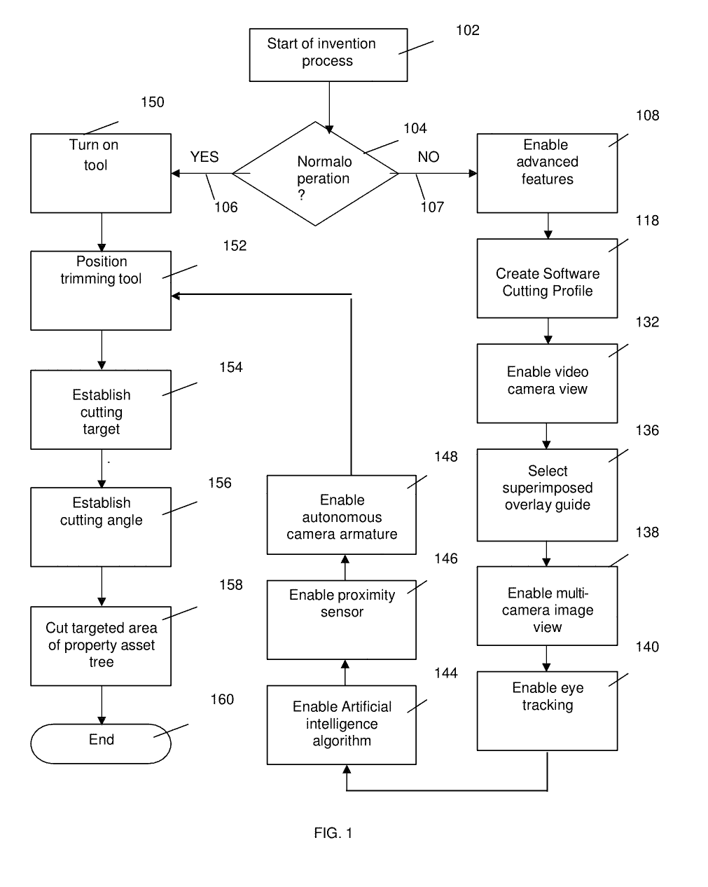

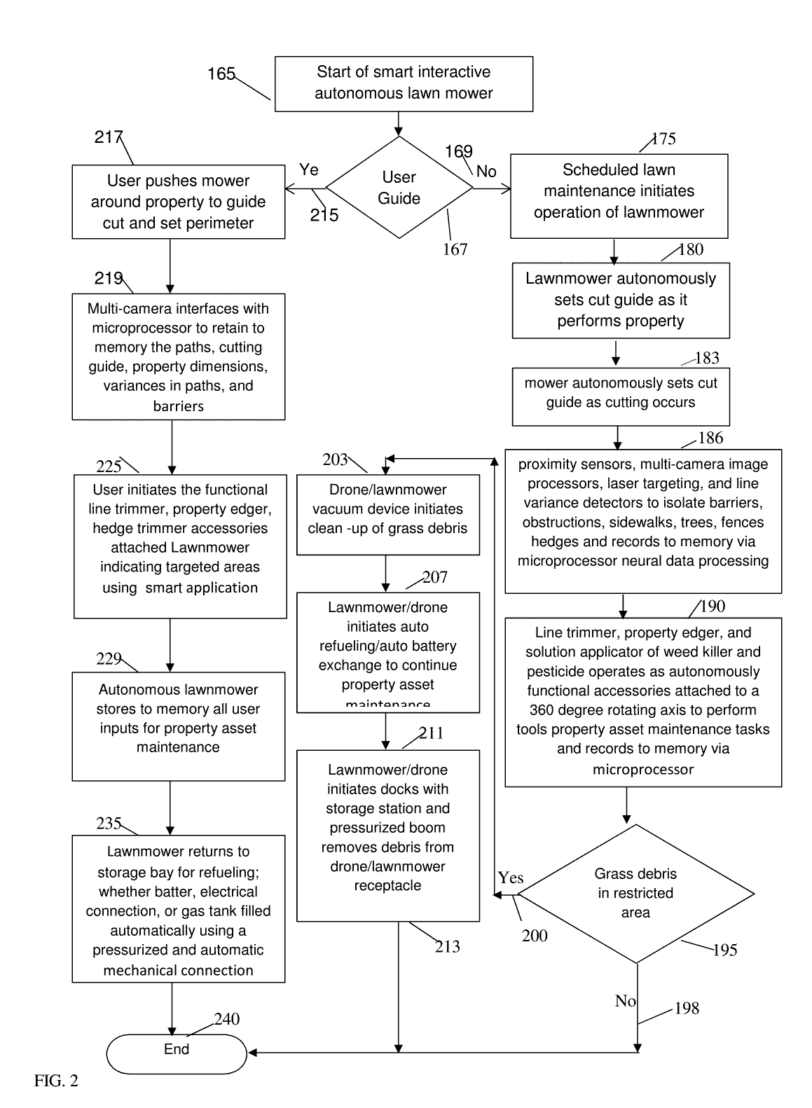

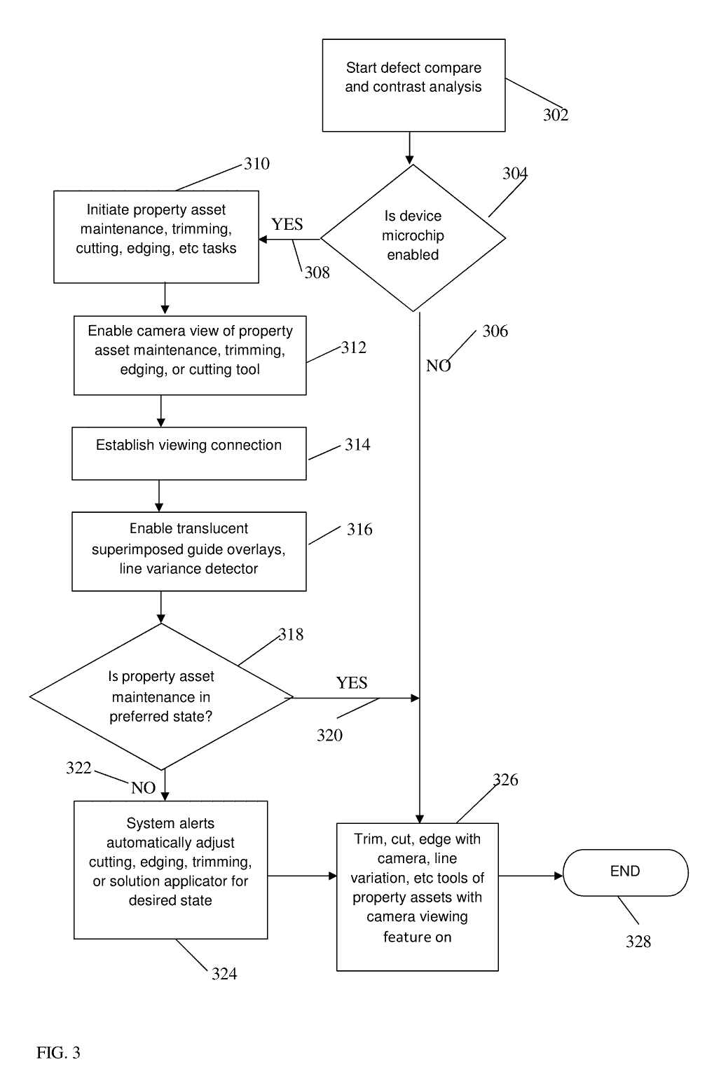

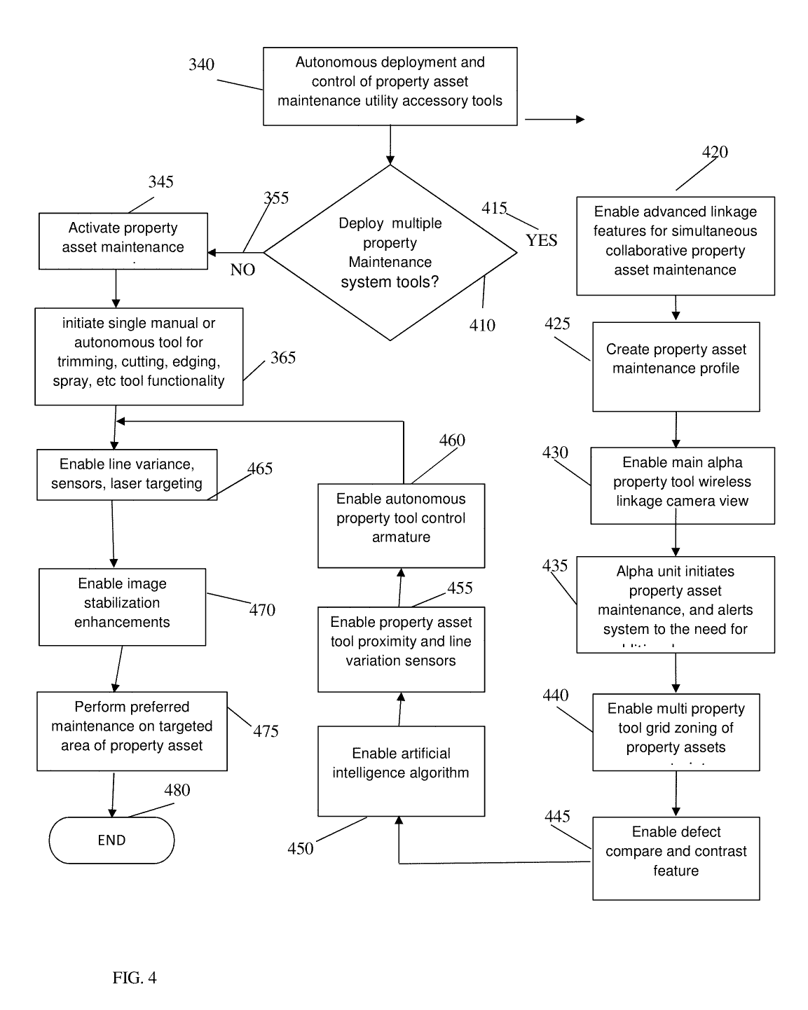

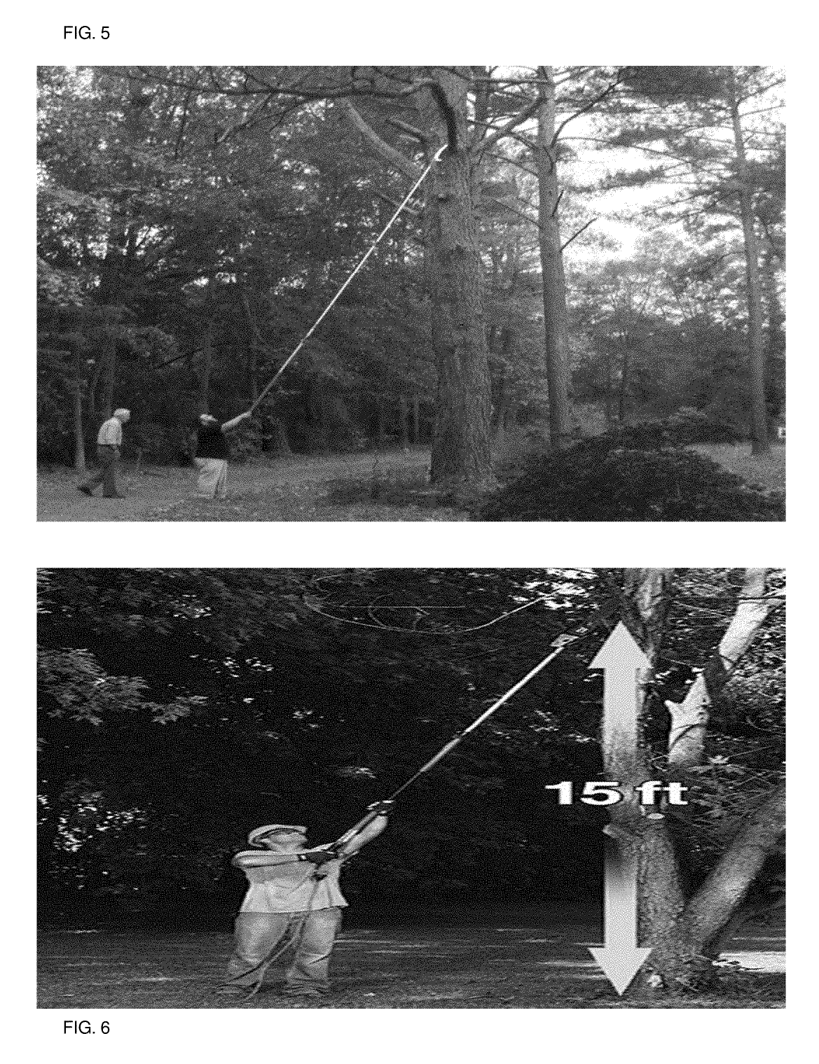

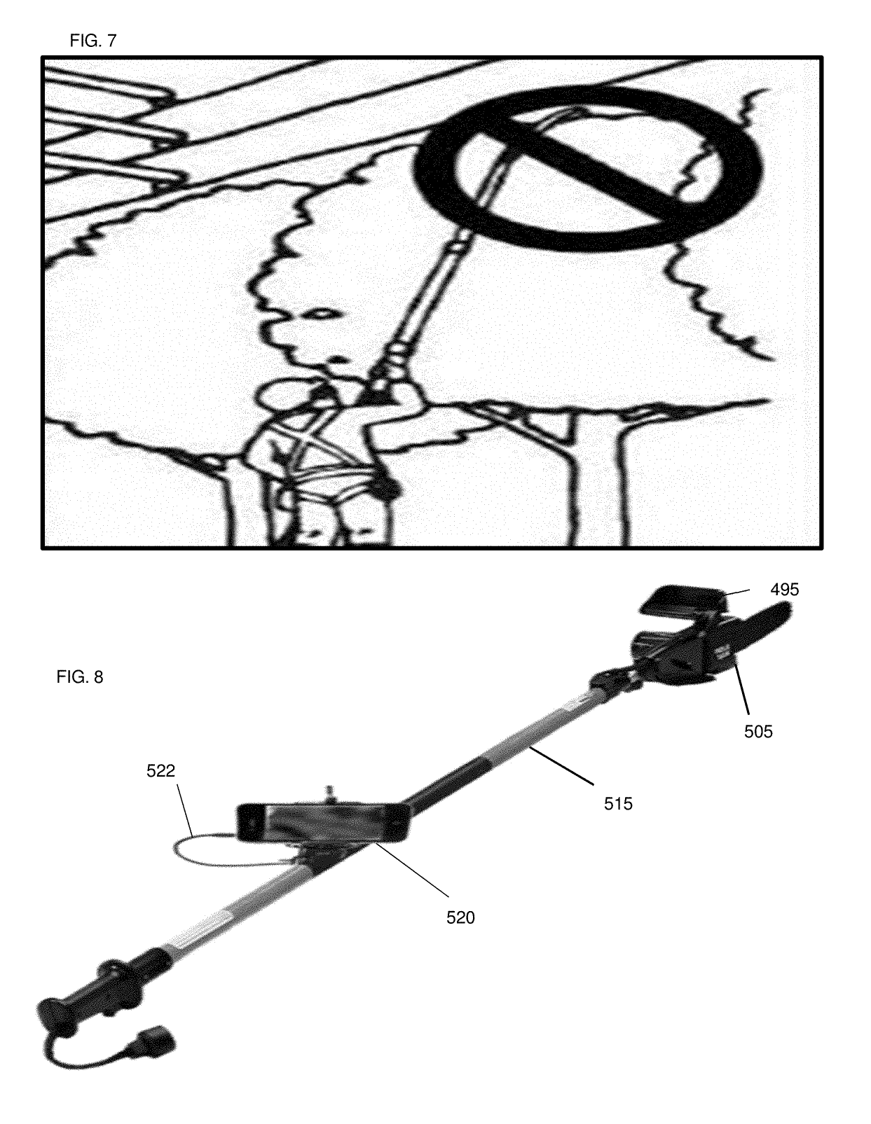

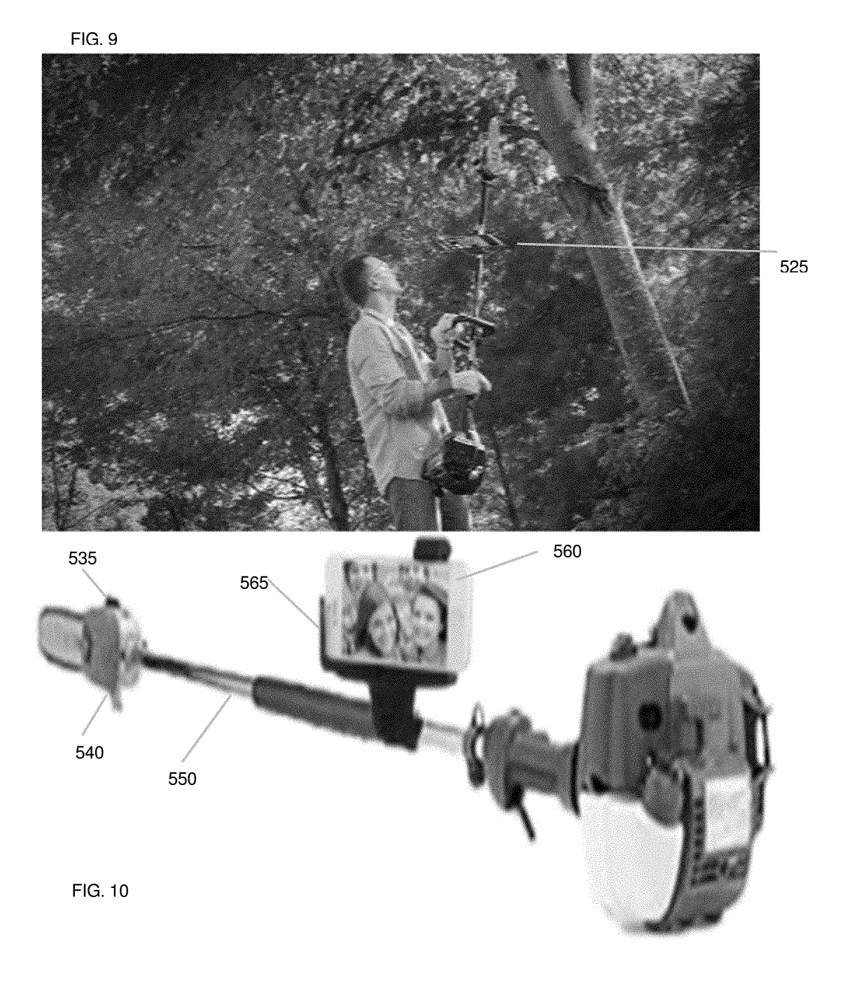

$${e}^{x} = 1 + \frac{x}{1 !} + \frac{{x}^{2}}{2 !} + \frac{{x}^{3}}{3 !} + … , - ∞ < x < ∞ .$$

Alternatively, the fluidic floating line feed apparatus can increase line length using an automatic mechanical feed process using the proximity sensor, pulley system, smart camera, and a microprocessor. In an alternate embodiment, the floating armature 1510 having a line feed port 1530, has a mechanical roller apparatus with microgrooves providing or device providing friction to enable forward or reverse directional control of line feed to extend the length of the line used to trim property asset or to untangle line in storage compartment

FIG. 36 is an image of a smart autonomous seed and wet and dry fertilizer spreader 1540 where the bags of seed, fertilizer or else has a small rfid chip qrcode, bar code or similar multidimensional or color coded feature function that uses a receiver, reader or camera to initiate preprogrammed operational controls. The product containers will automatically lock into place 1550 securely so that with user placing seed bag or bin into spreader device, the system will analyze the amount of product remaining and either reduce or increase the rate of disbursement, or if there is a dead spot area in the lawn, will add some growth enabler such as a spray liquid or foam solution to enhance the growing medium area in which the seed is being dispersed. In addition, a camera device 1560 analyzes the field of view and looks at the line variance to automatically set the spreader shoot 1570 range from 360 degree to 180 degree to 90 degree to 45 degree so any seed or feed product will only be deposited onto area of grass and no/limited product is spread onto sidewalk, tree root or hedge bush undercarriage or driveway areas. These functions can be implemented on an autonomous smart device, a user manually pushing or pulling being a mower, or a user wearing a strapped on manual device walking the targeted area where seed or fertilizer product needs to be spread. If the container of product is not emptied during the latest spreading effort, the smart device automatically seals the product container until the next time the product is used in conjunction with the spreader device

FIG. 37 is an illustration of a smart autonomous tire changer chassis apparatus having a camera, targeting system, gyroscope, balancing sensor, stabilizing arms, tire jack with alternative embodiment of either electric—pumping action—balloons—hydraulic bottle or floor—pneumatic—in varying sizes portable dc or oversized with autonomous rear tire chocks and jack stands which morph into modulated parts of the main smart autonomous tire changer chassis apparatus where the chocks or stands sensors continuously send data status on the balancing, movement, or pressure etc readings and where autonomous armature extends using a targeting system and camera to remove the lug nuts using appropriate lug nut tools. An alternative embodiment would be to enable oil filter and oil pan emptying process method as well. Both portable so a user can place into car truck for roadside tire changes while traveling or as an exchangeable module housed within the charging pod station. Alternatively, the autonomous chassis apparatus can be the main powertrain for interchanging other functional accessories such as the lawnmower, weed trimmer, edger, etc device

FIG. 38 is an illustration of the front view of the trash can robot capable of systematically moving a trash can receptacle from its storage location to the street area so municipal trash collectors can empty the unit into the garbage truck

FIG. 39 is an illustration of a robotic trash can device using a retractable arm positioned on a gimbal and gyroscope to push the trash can to the street area having a gps system and route optimization AI system; a distance sensor; a balancing sensor; a tilt indicator sensor attached to the garbage can; a calendaring program to schedule pickup dates; a mobile, wearable, cloud, internet interface, a weighted base to offset the weight of the refuse placed in the garbage can, a track system base or multi-wheeled base, a pulley system attached to a retractable arm with a claw device; automated return to base for charging feature, a single or multi-positioned camera system,

FIG. 40 is an illustration of a robotic trash can apparatus using magnetic levitation platform and arm to hover the trash can above the device while relocating the trash can to street level and return the unit to its storage location having a gps system and route optimization AI system; a distance sensor; a balancing sensor; a tilt indicator sensor attached to the garbage can; a calendaring program to schedule pickup dates; a mobile, wearable, cloud, internet interface, a weighted base to offset the weight of the refuse placed in the garbage can, a track system base or multi-wheeled base, a pulley system attached to a retractable arm with a claw device capable of attaching to a support bar and lifting trash can as necessary; automated return to base for charging feature, a single or multi-positioned camera system, voice command automated attendant, user profile management, face recognition, voice response system, solar powered system, solar or electrically connected trash compactor system, theft deterrent system, alarm, modulated system repairs, or modulated operational device and method as part of a home care system with interchangeable base or functional apparatuses, capable of allowing user to place trash receptacle container such as a recycling bin on the top platform of the robotic device to deposit on the side curb for emptying, and using a grappling claw retractable arm or magnetic levitation or toting method and return the trash bin to the users designated location upon being emptied; pully, clasping apparatus, and control arm apparatus and system to gradually place garbage can on the inside street area adjacent to the sidewalk curb from atop the sidewalk area; weighted counter measure to control the maneuverability and balancing of the garbage can while being positioned by the robotic device, a retractable arm used as a buttress to allow the pully, clasping apparatus, control arm apparatus and system to restore the garbage can to an upright position should it lose balance when emptying or due to weather, or mischievous behavior so that the garage can be restored to the storage area

FIG. 41 is an illustration of a robotic trash can apparatus with a trash can being placed onto the top platform capable of revolving 360 degrees for relocating trash can having a gps system and route optimization AI system; a distance sensor; line variance sensor, height variance sensor, a balancing sensor; a tilt indicator sensor attached to the garbage can; a calendaring program to schedule pickup dates; a mobile, wearable, cloud, internet interface, a weighted base to offset the weight of the refuse placed in the garbage can, a track system base or multi-wheeled base, a pulley system attached to a retractable arm with a claw device; automated return to base for charging feature, a single or multi-positioned camera system, using wifi, wifi direct, internet, Bluetooth, rfid, or any wireless connection protocol type to transmit and communication between devices, apparatus, to drive methods within a built-in mesh network for continuous communication with each device or apparatus being a mesh network node using omni-directional omni-route optimization relay protocol methods

FIG. 42 is an illustration of a front view of the robotic trash can apparatus with trash can atop the platform

FIG. 43 is an illustration of the robotic trash can mover in charging docking station

FIG. 44 is an illustration of a power tool pole saw mobile device holder

FIG. 45 is an illustration of the improved invention cross sectional front view with sub tools loaded in the chamber's slots

FIG. 46 is an illustration of the improved invention side view of the cylinder chamber housing the grouping of related sub tools

FIG. 47 is an 3d rendering image of the current invention, and how the peer to peer secure mesh network apparatuses communicate with each other so the drone 1790 sends real time data feeds to the autonomous lawnmower 1800. This improved invention uses various property maintenance devices to work cohesively as one based on owner restricted geo-location geo-fencing 1820 communicates with drones 1810 that scan the area continuously

FIG. 48 is an image of the new invention wet and dry rechargeable battery 1860 powered property maintenance treatment sprayer distribution water gun with trigger 1870 like apparatus with changeable nozzle 1850 how the improved invention uses similar drive train apparatus to power the interchangeable cylinder chambers with status window 1840 and exchangeable single use prefilled treatment pods snap into place 1830 holding wet or dry pesticide, herbicide, insecticide, fertilizer

FIG. 49 is an image of the new invention wet and dry pump action 1920 powered property maintenance treatment sprayer distribution water gun like apparatus with changeable nozzle 1880 where single use treatment pods 1910 load in the gun sprayer rear with trigger 1930. Alternatively, the treatment pods can be cartridges loaded in the bottom or front and the treatment sprayer can either be premixed 1890 prefilled mixture or a smaller size concentrate that the user adds water to the hopper tank to mix before distribution

FIG. 50 is an image of the new invention multi sprayer cylinder 1950 for having different types 1940 of single use treatment sprays pods 1970 on affected property maintenance for one stop dial up the treatment you need for weeds, insects, wasps, spiders, fertilizers 1960

### REFERENCE NUMERALS

102—Start of the process using the camera apparatus invention
104—normal view decision gate
106—affirmative to normal view using image capture device
107—Negative to normal operation
108—turn on invention tool advanced features
118—Create software cutting profile
132—enable video camera view
136—select superimposed design guide
138—enable multi-camera image view
140—enable eye tracking
144—enable artificial intelligence algorithm
146—enable proximity sensors
148—enable autonomous camera armature
150—turn on tool
152—position trimming tool
154—establish cutting target
156—establish cutting angle
158—cut targeted area of property asset tree
160—end of process
165—start of smart interactive autonomous lawn mower process
169—user guided decision gate
167—Negative to user guided operation
175—lawn maintenance schedule initiated operation of lawnmower
180—lawnmower autonomously sets cut guide
183—mower autonomously sets cut guide as cutting occurs
186—proximity sensors, cameras, laser targeting, line variance functions
190—line trimmer, property trimmer functional accessory autonomously deploys
211—successful property results after defect compare and contrast analysis system
213—unsuccessful property results after defect compare and contrast analysis system
495—top view camera on electric powered invention
505—bottom view camera on electric powered invention
515—electrical pole saw invention
520—mobile device
522—connection cable
525—gas powered interactive pole saw
535—top view camera on gas powered invention
540—bottom view camera on gas powered invention
550—gas powered pole saw invention
560—mobile device
565—display device attachment
570—battery powered pole saw invention
580—mobile device interactive interface
590—unmanned aerial vehicle drone
600—aerial drone user controlled device
610—microchip for enabling the property maintenance tool as a smart autonomous unmanned aerial vehicle drone apparatus
620—retractable articulating support on attached to gimbal
630—autonomous or remote controlled powered saw
640—lower multi-point camera
660—upper multi-point camera
670—remote controlled or autonomous unmanned aerial vehicle drone
680—camera
690—upper multi-point camera
700—lower multi-point camera
710—powered saw
715—remote or autonomously controlled unmanned aerial vehicle drone
720—gimbal articulating gyroscope
730—gimbal enabled elbow support arm
740—retractable articulating support arm with power transfer
750—lower multi-point camera
760—upper multi-point camera
770—powered hedge trimmer
780—autonomously or remote controlled unmanned aerial vehicle drone
790—directional camera
800—hedge trimmer blade
810—rotational 360 degree directional camera on electric or battery powered mower
820—360 degree rotational axis for accessory functional tools on electric or battery powered mower
830—gimbal articulating gyroscope line trimmer support arm on electric or battery powered mower
840—line trimmer camera
850—line trimmer proximity sensor on electric or battery powered mower
860—smart autonomously opening grass discharge port on electric or battery powered mower
870—autonomous property edger
880—rear smart autonomously opening grass discharge port
890—rear grass catcher receptacle
900—rear handle support locking mechanism on electrical or battery powered mower
910—rotational 360 degree directional camera on gas powered mower
920—gimbal articulating gyroscope property edger support arm on gas powered mower
930—laser sensor line generator
940—property edger camera
950—gas powered autonomous property edger
960—gimbal gyroscope on gas powered mower
970—360 degree rotational axis for accessory functional tools on gas powered mower
980—rear handle support locking mechanism on gas powered mower
990—line trimmer proximity sensor on gas powered mower
1000—smart autonomous line trimmer on gas powered mower
1010—smart autonomously opening grass discharge port on gas powered mower
1020—smart gutter cleaning accessory attachment with camera
1030—interactive mobile device
1040—pole tool with multi-functioning tool accessories
1050—light bulb
1060—smart light bulb changer accessory tool
1070—smart light bulb changer accessory tool directional camera
1080—bit driver
1085—screw bit
1090—screw
1100—spring loader
1110—screw feeder
1120—support track
1130—smart gutter cleaning accessory with camera cleaning gutter
1140—attachment with interactive smart phone
1150—interactive pole tool with interchangeable functional accessory head
1160—user
1170—house needing gutters, down sprout, etc cleaned with interactive pole tool
1180—drone rotor
1190—autonomous adjustable drone panels that tilt, span, and rotate for trimming hedge or tree sides
1200—drone cutting apparatus
1210—drone adjustable panel
1220—drone retractable panel or trimming hedges or tree tops
1230—drone support brackets for adjustable drone panels
1240—drone rotor engine
1250—drone cutting head
1260—hedge or tree being trimmed by drone
1270—drone rotor battery or fuel
1280—debris or leaves vacuum attachment
1290—mechanical debris or leaves vacuum bag receptacle
1300—property grid superimposed overlay using artificial intelligence algorithm
1310—property grid superimposed overlay with defect analysis algorithm identifying terrain irregularities
1320—user driven manual pumping mechanism to store energy to power manual pole saw
1330—bottom limiter point for initiating stored energy to power property tool
1340—top limiter point for initiating stored energy to power property tool
1460—autonomous grass trimmer
1470—smart interactive multi-view camera system
1480—smart proximity sensor
1490—smart fluidic line feeding system
1500—smart fluidic floating line feeding system
1510—floating flexible armature
1520—floating flexible armature line port
1530—floating flexible armature line guide

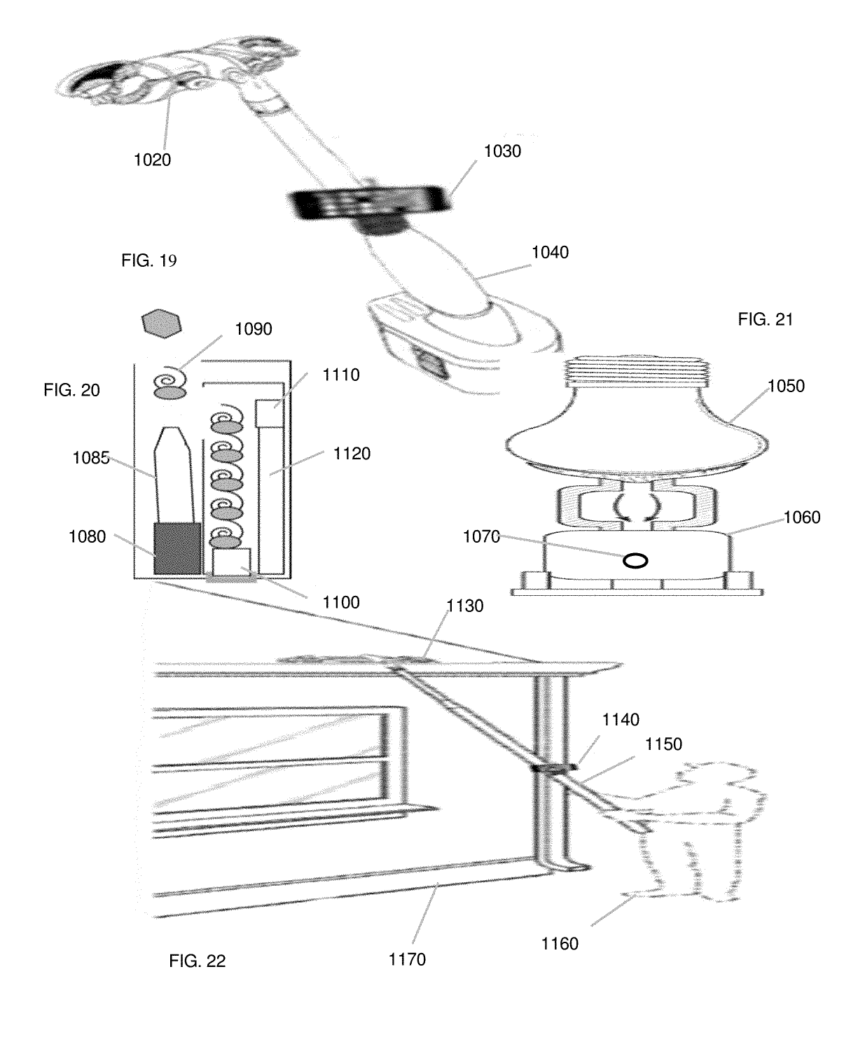

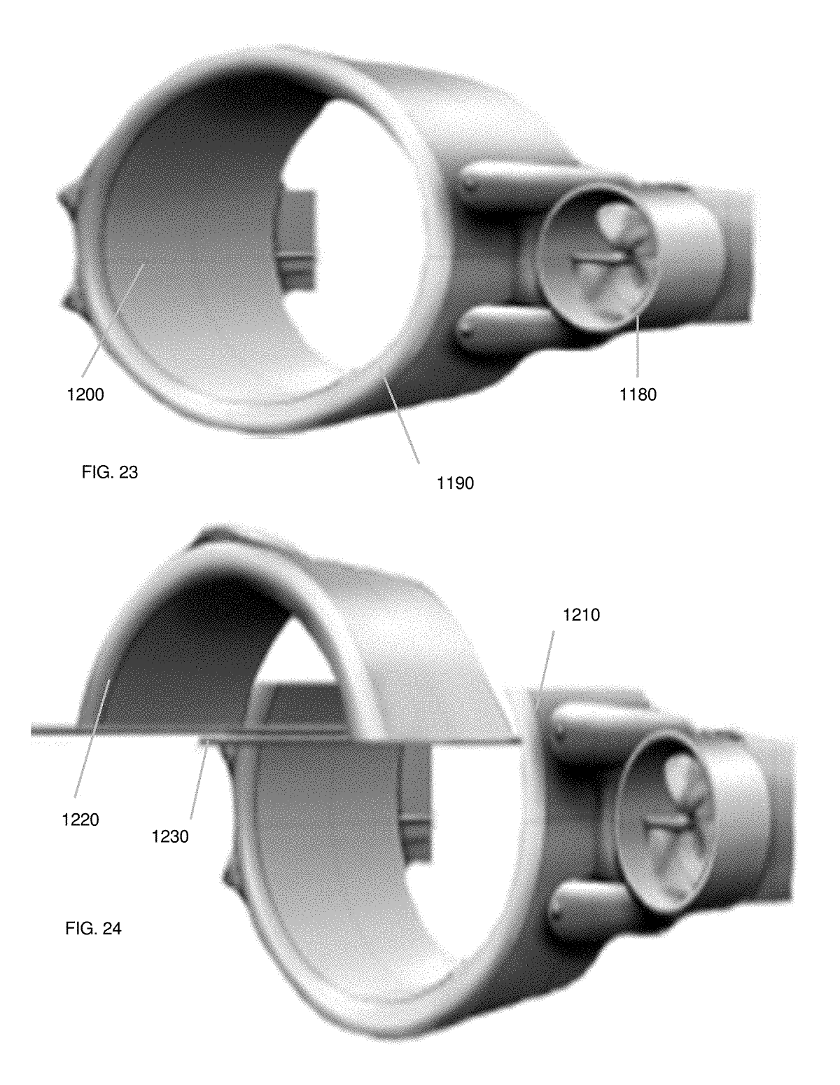

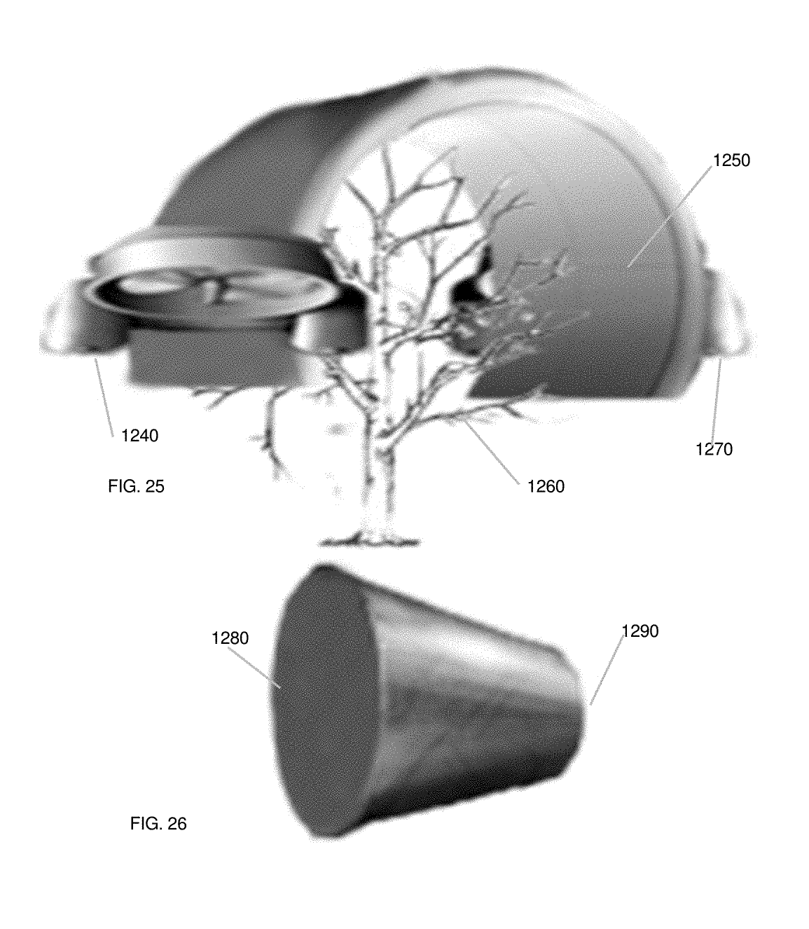

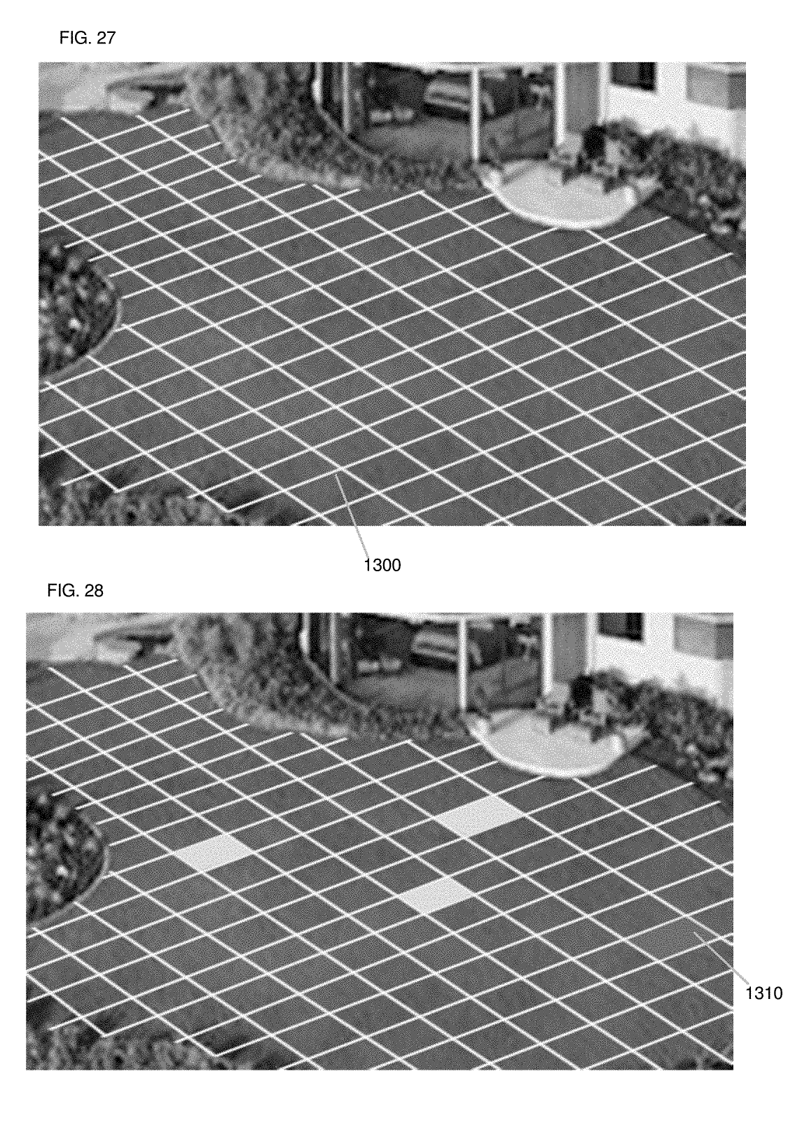

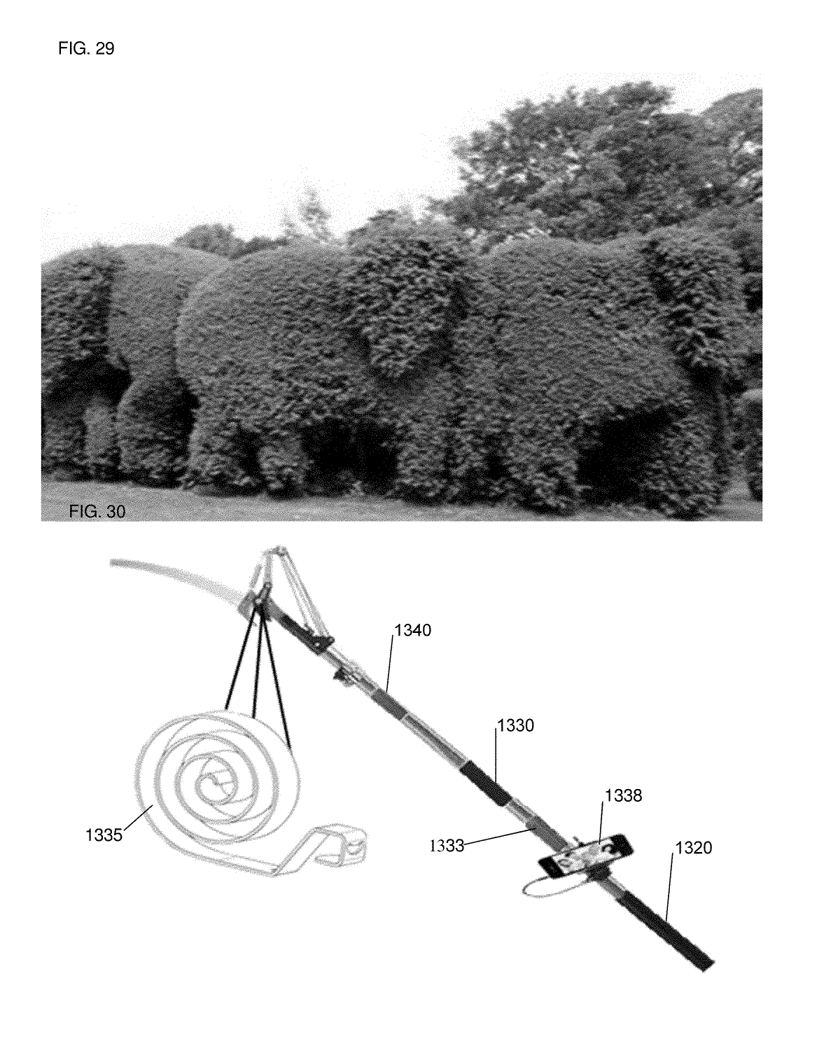

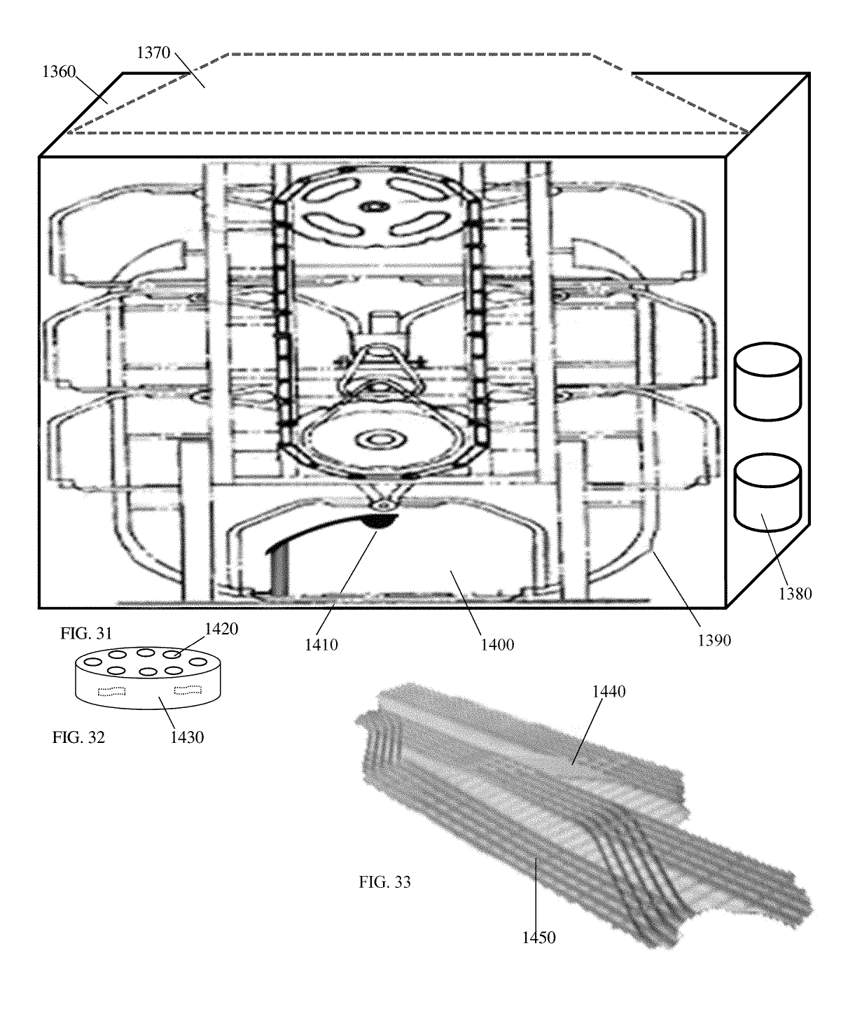

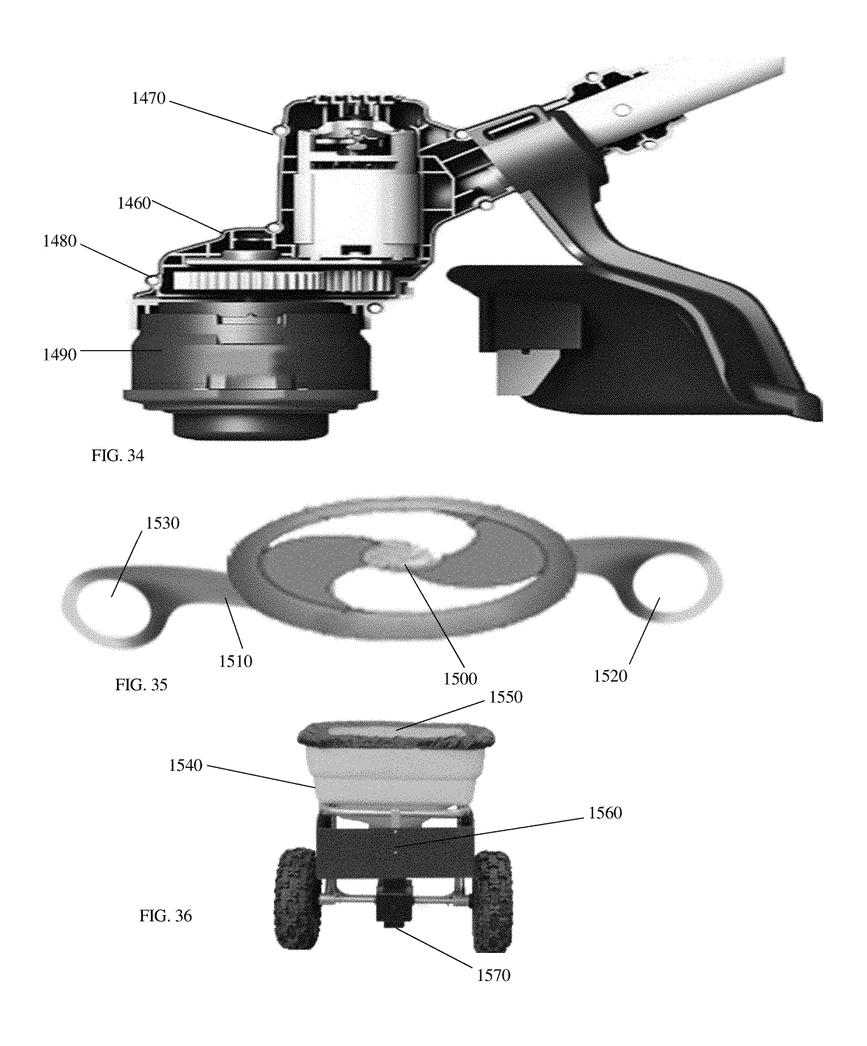

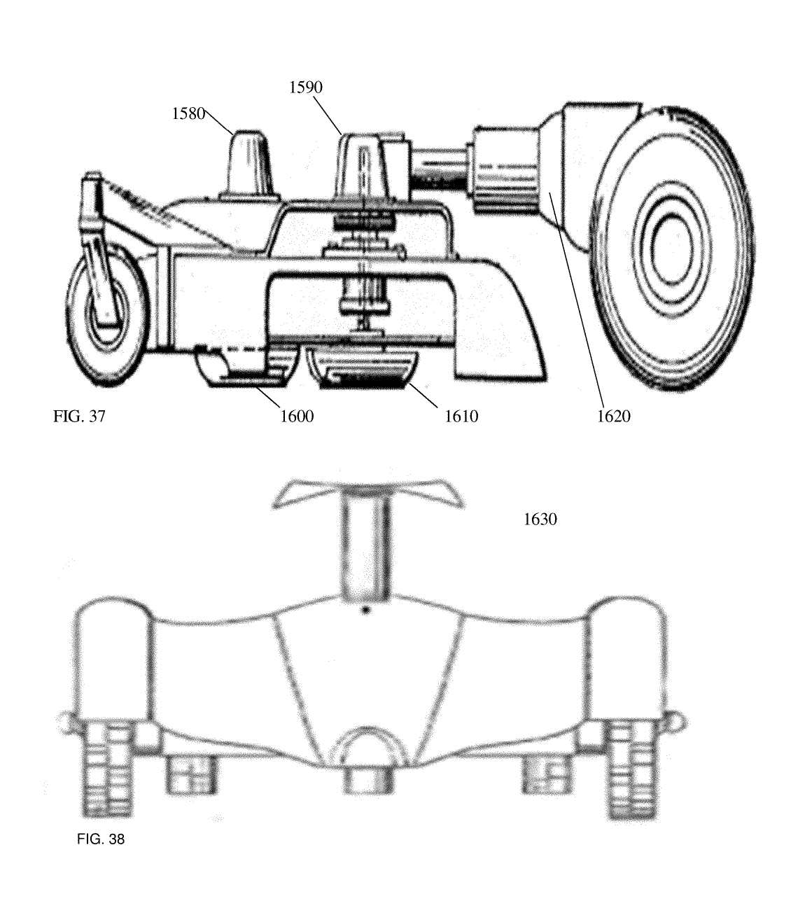

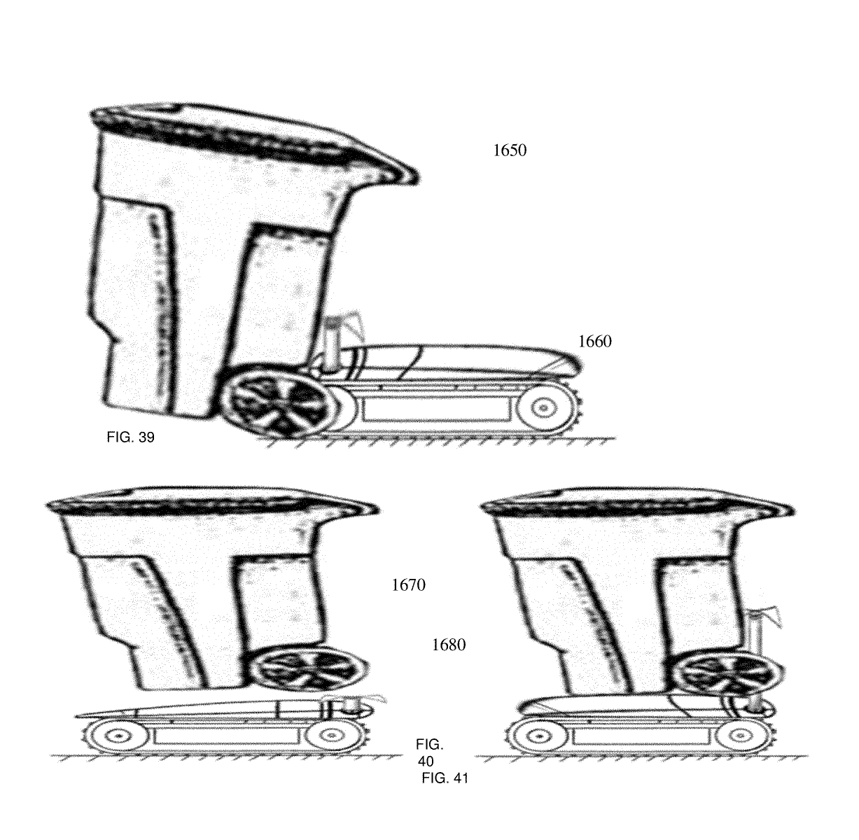

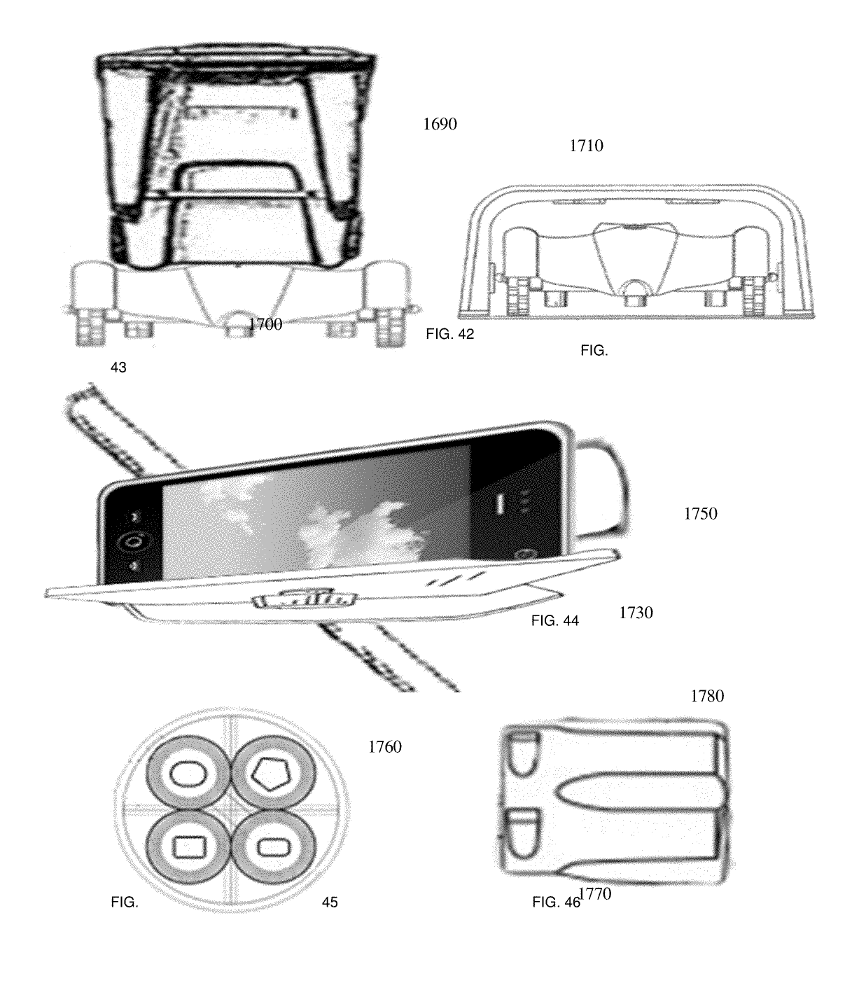

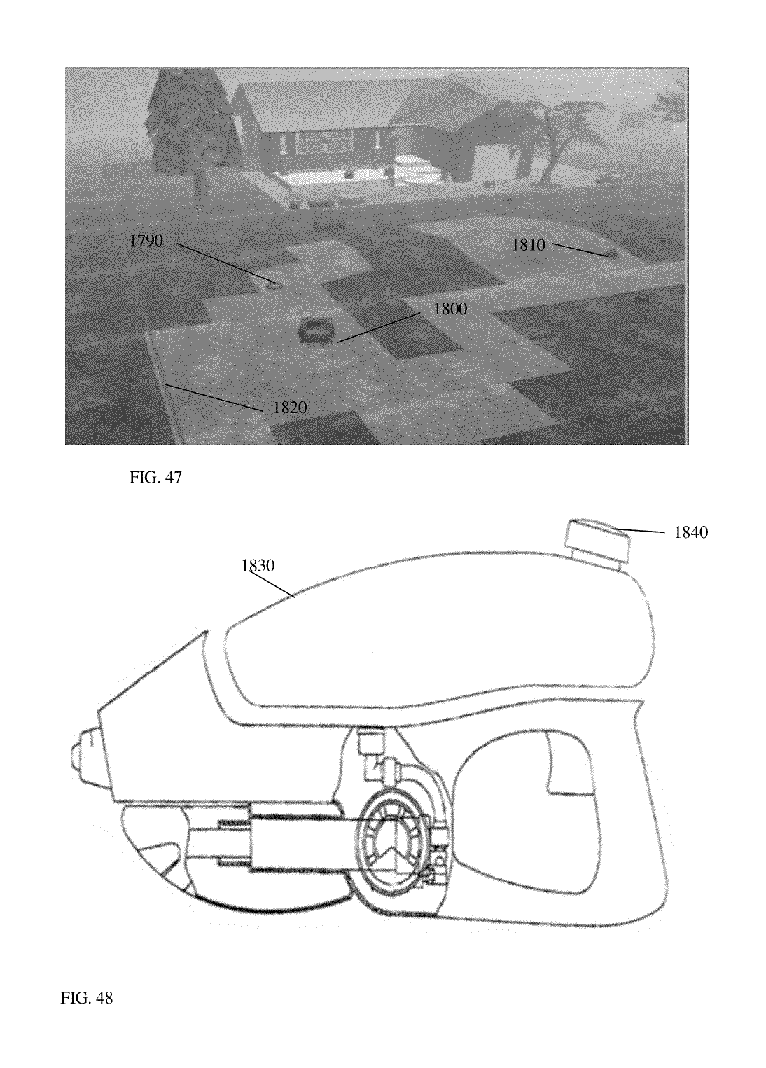

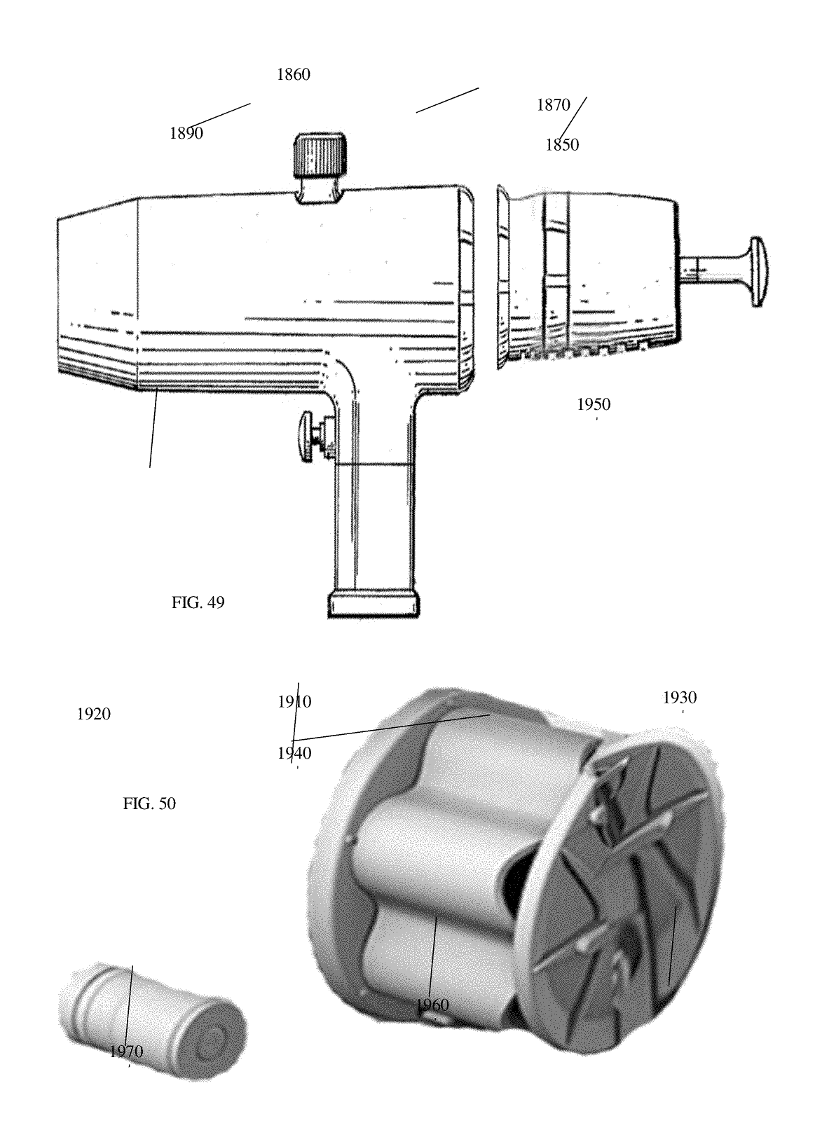

In the use of the 102 present invention, the use of an image capture device (ICD) 110 includes at least one sensor and one input component for detecting and recording images, a processor, a memory, a transmitter/receiver, and optionally, a hard wired 2101 electrical feed or rechargeable battery FIG 19, having at least an indicator light for denoting camera activities, all constructed and configured in electronic connection interfaces for viewing targeted property asset maintenance area using the image capturing device invention as an attachment or hard wired FIG. 21 apparatus with the preferred embodiment property asset maintenance 222 tool with fixed or exchangeable cutting maintenance heads.

In a preferred embodiment of the present invention being a property asset pole saw having a microchip 310 hard wired within the tool's electrical circuitry, an image capture device interfaced with the artificial intelligence system, a property asset maintenance tool comprising: a motor; a bladeset including an elongated cutting support guide and a moving chain configured for rotation relative to stationary guide have a microchip 1402 embedded in member, a drive system configured for transferring motion from output shaft to bladeset, and including a driving member separately formed from moving chain and moving rotational along an axis transverse to a longitudinal axis of property asset tool; and the embodiment of the property asset maintenance apparatus' drive system includes a linear drive shaft and driving member is relative to a chassis, ends of drive shaft are received in corresponding arms of chassis, drive system is configured so that the driving member rotates parallel to bladeset guide throughout a stroke of driving member; driving member being linearly rotational along an axis defined by linear drive shaft extending transverse to output shaft to provide linear motion of moving cuttirg head relative to stationary guide, allowing the ICD and the video disalay device (VDD) as the preferred embodiment of invention apparatus being a pole saw, autonomously functional accessory attached to an aerial drone, or an autonomous robotics lawnmower to be automatically controlled operationally during property asset maintenance.

In this alternative embodiment, a robotic property apparatus and system kiosk or portable property robotic system and device having one or more robotic mechanical systems; analyzing one or more electronic property portraits for presenting preprogrammed commands to the central processing unit in order to process the user's property selection. After which, a comparison between one layered image is compared with a subsequent image captured and processed to include a superimposed design overlay; activating the movement of robotic mechanical systems to apply property asset maintenance, with the mechanical system being controlled by an optical sensor processing images based on the design overlay, thereby applying property asset maintenance.

Image acquisition refers to the taking of digital images of multiple views of the object of interest. In the processing step, the constituent images collected in the image acquisition step are selected and further processed to form an interactive sequence which allows for the interactive view of the object. Furthermore, during the Processing phase the entire sequence is compressed. In the Storage and Caching Step, the resulting sequence is sent to a storage memory. In the Transmission and viewing step, a Viewer (user) may request a particular interactive sequence, for example, by selecting a particular image within a album of available captured files, which initiates the software system for performing property asset maintenance, checking of view, decompression and interactive rendering of the sequence on the end-users display device 112, which could be any one of a variety of devices, including a hand-held device, smart glasses, augmented reality, wearables using a variety of transmission methods such as Bluetooth, electrical Ethernet adapter, DLNA, wifi, RF, USB, hdmi, coaxial, streaming to name a few :hat those skilled in the art know the full scope of transmission options.

The system processing flow can be broken into four main phases:

### 1.Image Acquisition

### 2. Processing

### 3. Storage

4. Transmission and viewing

For the preferred embodiments where the ICD includes a digital video camera (DVC) having a lens and corresponding camera components, the camera further includes a computer chip providing for capabilities of performing video compression within the ICD itself. The ICD as a wireless digital video camera is capable of capturing video within its range with an accompanying video display device (VDD) 602 as a still capture frame shot and/or compressing the captured video into a data stream in the form of a mobile device 204, television monitor, computer or display unit. In the case of video, the images are adjustable to capture at different sizes, different frame rates, multi-display of images, display system information, and combination thereof.

The VDDs of the present invention are capable of running software for managing input images from at least one wireless or wired ICD associated with or corresponding to a particular VDD device after software installation and initiation. The VDD device is programmable for wireless communication with image capture device, including both transmitting data, settings, controlling instructions and receiving input captured from the ICD, Ske images, video, audio, temperature, chemical presence, and the like to perform property asset maintenance

Thus, the VDD device is capable of receiving wireless data from the wireless image capture device(s), indicating that the ICD is active, recording data and storing data, searching through recorded data, transmitting data and instructions to the ICD, adjusting ICD settings or controls, communicating with the present invention system software to send and receive data, and other functions, depending upon the specifications of the system setup.

The ICD further includes at least one microchip that makes the device an intelligent appliance, permitting functions to be performed by the ICD itself without requiring software installaton onto the VDD. including but not limited to sensor and input controls, such as camera digital zoom, pan left and right, tilt up and down; image or video brightness, contrast, saturation, image stabilization and recognition, resolution, size, motion and audio detection settings, multi-view image display, recording settings, communication with other ICDs; and video compression. Other software-based functions capable of being performed by the VDD include sending text message, sending still image, sending email or other communication to a user on a remote communications device.

The user may select one of the “known property assets” or may create a new “property asset” with an associated set of “profile” data in the image classification database. This database includes an appearance list for each of the “known property assets” containing one or more identities and a table of image classes associated with each such property asset identity. Multiple identities can be associated with each property asset because assets typically change their state in seasonal shifts. Examples of such instances of varying appearance may be handling a property asset with/without falling leaves; with/without falling tree branches, etc. In addition, there may be a chronological description where the progress over time which may manifest in changes in length, thickness or lack thereof, etc. Within each property asset class is preferably grouped a set of similar identity prints which are associated with that property asset class for that asset in order to maintain property asset based on a superimposed preferred state that is also selected. The database module may also access additional information on individual images, including image metadata, camera metadata, global image parameters, color dataset of information, etc., which may assist in categorization and search of images. If the user selects a “known identity”, then if this new identity print is sufficiently close to one of the property asset classes for that identity, it will be preferably added to that identity class. Otherwise, in “manual” or “learning” mode the user may be shown a typical image representative of each property asset class and asked which identity class the idenitity print should be added to, or if the/ wish to create a new identity class for that property asset. In “auto” mode, a new identity class will be created by the workflow module for that property asset.

A system for optical section imaging, comprising: a camera for recording a plurality of input images of an imaging surface; a grid using object geospatial positioning system; an optical sensor virtual lamp for shining light at the grid to project a grid pattern onto the imaging surface so that each of the input images includes a corresponding grid pattern at a corresponding angle; an actuator for shifting the grid between each input image recordation so that the grid patterns of at least two of the plurality of input images are at different phase angles; and a processor configured to: calculate, for each of the plurality of input images, the image's grid pattern angle; generate a first output image by calculating for each pixel of the first output image a value in accordance with a corresponding pixel value of each of the plurality of input images and the calculated angles; and generate a second output image by removing an object included in the first output image, wherein the object is removed one of: by (a): determining a contribution of the object to image intensity values of the first output image; and subtracting the contribution from the image intensity values; and by (b): applying an image transformation to the first output image to obtain transformation data; deleting a predetermined portion of a transformation image representing the transformation data, the transformation data being modified by the deletion of the predetermined portion; and generating a non-transformation superimposed 702 overlay image based on the modified transformation data while using artificial intelligence along with superimposed overlays for automatic operational control of property asset maintenance tool or functional autonomous accessory line trimmer, property edger, etc.

A computer-readable medium havng stored thereon instructions adapted to be executed by a processor, the instructions which, when executed, cause the processor to perform an image generation method, the image generation method comprising: generating a first output image based on a plurality of input images; determining a contribution of an object to image intensity values of the first output image by determining values of a horizontal and a vertical direction; generating a second output superimposed 704 overlay image based on the first output image, the second output image being the same as the first output image less the object, including subtracting the contribution from the image intensity values, the subtraction including: determining values of the equation by plugging pixel area

What is needed, therefore, is an inspection technique that is effective in locating pattern anomalies or defects in a single or a multi object image layer. The system by manual maneuver with user capturing an image of the plane(targeted positional point) and takes snapshot images and places them into a threaded connection interface (TCI) that with each passing snapshot a comparison of any changes or deltas occurs, through the central processing unit (cpu) and stores snapshots in a central memory storage; there in allowing for the placement of a selected superimposed design overlays by user upon property asset for the intelligent interactive image views processing task. A method consistent with the invention may further include comparing, using an artificial intelligence engine 144, the received property asset-specific information with the accessed data, as illustrated. Comparing may include determining the appropriateness of pieces of the accessed data for the property asset based on the property asset-specific information using predictive analysis and artificial intelligence within the instructional training guidance system used with the superimposed overlays to accurately maintaining property asset. “Artificial intelligence” is used herein to broadly describe any computationally intelligent training systems that combine knowledge, techniques, and methodologies. An Al engine may be any system configured to apply knowledge and that can adapt itself and learn to do better in changing environments. Thus, the Al engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the Al engine may learn to adapt to unknown or changing environments for better performance when property asset maintenance apparatus is linked with the ICD, VDD, and using superimposed overlays. Thereby allowing the preferred embodiment of the present invention apparatus property asset tool being automatically controlled for better operational management while maintain property asset.

In an additional embodiment, the method may include comparing the potential defects of interest to the results generated by design rule checking performed on design pattern data of the object to determine if the defects of interest correlate to design rule checking (DRC) critical points of differentiation between the output images displayed on VDD. In one such embodiment, the method may also include removing from the inspection data the defects that do not correlate with the critical points based on property asset being maintained using the superimposed 706 overlay grid property asset preferred maintenance state patterns. In a similar manner, the method may include comparing the potential defects of interest to the results generated by optical rule checking (ORC) performed on design pattern data of the object. In general, steps described herein involving the use of VDD results may alternatively be performed using ORC results. Each of the embodiments of the method described above may include any other step(s) described herein such as using a predictive analytical 146 compare and contrast 224 algorithm where the calculation of aerial or sequential camera pass capture view of image object pixels, color variation, etc in differing layers of superimposed 802 overlay image to the original image are compared for accuracy to the original property design for improved instructional guidance training using artificial intelligence to further autonomously control the operational function of the property asset maintenance tool or autonomously control the functional accessory line trimmer, edger, etc tool to reach the desired maintenance state.

A storage medium, comprising orogram instructions executable on a computer system to perform a computer-implemented method for sorting defects in a design pattern of an object, wherein the computer-implemented method comprises: searching for defects of interest in inspection data using priority information and defect attributes associated with individual defects in combination with one or more characteristics of a region proximate the individual defects and one or more characteristics of the individual defects, wherein the inspection data is generated by comparing images of the oroperty asset object to each other to detect the individual defects in the ideal asset maintenance state pattern of the property asset object, wherein the images that are compared 224 to each other are generated for different values of a superimposed 1104 overlay design variable, wherein the images comprise at least one reference image and at least one modulated image, and wherein the priority information is derived from a relationship between the individual defects and their corresponding modulation levels of the property asset maintenance contoured state design variable; and assigning one or more identifiers to the defects of interest.

The overlay images may also be illustrated to the user in other manners. For example, the user interface may be configured to display any of the defects or just the sample images intermittently with reference images corresponding to the defect images. In this manner, the images may appear to highlight in the property asset maintenance video display device interface repeatedly one after the other. Such “highlighting” of the images be user analyzed and acted upon or autonomously performed by property asset maintenance tool to gain additional understanding of the differences between the image layers. In a similar manner, sample images of differently modulated configurations may be highlighted in the user interface, which may aid in user or property asset tools' system's understanding of trends of the defects historically so the compare and contrast analysis 224 for improved property asset maintenance.

The methods described herein may also include a number of other filtering or sorting functions. For example. Ihe method may include comparing the defects of interest to inspection data generated by design rule checking (DRC) performed on design pattern data of the object layers to determine if the defects of interest correlate to DRC defects. In one such embodiment, the method may include removing from the inspection data the DRC defects that do not correlate with the defects of interest within the targeted property asset maintenance plane area. DRC could be a lenient based on tree. toy. sidewalk, or fence obstructions, or other source layer imperfections.

The present invention generally relates to computer-implemented methods for detecting and sorting defects in a design pattern of an object. Certain embodiments relate to a computer-implemented method that includes generating a composite reference image from two or more reference images and using the composite reference image for comparison with other sample images for defect detection. Interfaced with the Al engine, the multiple grid reference point positions and corresponding images may be used in order to generate an output image based on images corresponding to grid angles are the basis for the present invention method, system and apparatus property asset maintenance solution being used to accurately maintain a property asset based on the display views and superimposed overlay designs.

An imaging apparatus, comprising: a camera 906 for recording a plurality of input images; and a processor configured to: generate a first output image based on the plurality of input images; and remove an object from the first output image to generate a second output image; wherein, for the generation of the second output image, the processor is configured to: apply an image transformation in the form of a superimposed overlay property asset maintenance style in correlation to the first output image to obtain transmitted transformation data; delete a predetermined portion of a transform image representing the transform data 902 the transmitted transformed image data being modified by the deletion of the predetermined portion; and generate a non-transform image based on the modified transform data 802 embodied within the translucent superimposed overlay area 136. Furthermore, it will be appreciated hat the camera 110 may transmit each image after its recordation or may otherwise transmit them in a single batch transfer. An imaging apparatus, comprising: a camera for recording a plurality of input images; and a processor configured to: generate a first output image based on the plurality of input images; determire a contribution of an object to image intensity values of the first output image by determining values of variation in one of a horizontal and a vertical direction wherein the imaging apparatus 708. wherein the processor is configured to: determine a tilt of the superimposed 802 overlay pattern and autonomously controlled property asset tool operation or image stabilization 116 with respect to an imaging area of the at least one of the input images; rotate the transmitted image at least one of the input images to negate the tilt for proper orientation; for the software interfaced with the processor aligns the image captured by the ICC to maintain proper orientation using sensors for image pixel analysis

The processor may take various forms, including a personal computer system, mainframe computer system, cloud, workstation, network appliance, Internet appliance, personal digital assistant (“PDA”), smart phone 1008, smart eye wear, wearables, augmented and multi-dimensional display system or other processor enabled device. In general, the term “computer system” may be broadly defined to encompass any device having one or more processors, which executes instructions from a memory medium. In addition, the processor may include a processor as described here within incorporated by reference above, which are particularly suitable for handling a reatively large amount of image data substantially simultaneously.

Consistent with the imaging invention to determine the current health status of a viewable plan area for suggesting property asset maintenance fertilizer, weed killer, pesticide, etc prodjcts, an alternative embodiment of the imaging device, being a system, method, and apparatus that includes identifying, using a scanner machine or mobile imaging device ; embodied as a stand alone property asset maintenance lawnmower, edger, trimmer unit or part of a multi- functional device; wherein device allows for a user to guide the tool or autonomously operated property asset maintenance tool to operate using scanning or image capturing processing of property asset area, and using predictive analytics for identifying matching property asset maintenance promotional products based on the scanned or image processed health rating of the property asset's conditional state. Additionally, the system can send promotional coupons in digital form to a users mobile device using sms text messaging. Alternatively, the system can send promotional product coupons to a users online profile for loading property asset maintenance digital coupons on mobile device memory; property asset maintenance digital coupons placed on a stored value card or credit card; or properly asset maintenance coupon offers sent to users home address of record. In an alternative example embodiment of the present invention, the use of a mobile device having an image capture scanning device interfaced to a processor with OCR system capable of capturing the retail receipt to initiate the promotional product coupon being sent to user's mobile device for loading onto a devices memory and associated profile account.

Furthermore; for removal of an object area from an optical sectioning output image in an alternative example embodiment of the present invention, the system and method may remove a section of an image representing image transform data of the output image that is at a predetermined location of the transform image, i.e., a portion of the imace transform data that forms the portion of the transform image that is at the predetermined location may be removed.

Embodiments of the present invention relate to an apparatus, computer system, and method for generating an image via optical sectioning by determining angles of a grid pattern projected successively onto an object to be imaged for guidance of customized property asset maintenance designs using superimposed overlays

In an alternative embodiment, the processor 502 may cause the camera to record a single set of images of an object having a substantially uniform surface to determine the trimmer
708 property tool angles of the images caused by movement of the property grid 136. The processor 502 may save the determined trimmer angles in a memory 312. Alternatively, if the object to be imaged has a uniform surface or includes substantial detail so that substantial data may be obtained from an image of the object, the processor
108 may determine the optimum image trimmer angles from images of the object to be imaged, without previous imaging of another object that is inserted into the camera's line of sight solely for determining image property tool angles. Additionally in the present invention system and method, image and video analytics data is automatically sent to the invention system application.
The program instructions may be implemented in any of various ways, including procedure-based techniques, component-based techniques, and object-oriented techniques, among others. For example, the program instructions may be implemented using Matlab, Visual Basic, ActiveX controls, C, C++ objects, C#, JavaBeans, Microsoft Foundation Classes (“MFC”), or other technologies or methodologies, as desired.

Program instructions implementing methods such as those described herein may be transmitted over or stored on the carrier medium. The carrier medium may be a transmission medium such as a wire, cable, or wireless transmission link, or a signal traveling aong such a wire, cable, or link. The carrier medium may also be a storage medium such as a read-only memory, a random access memory, a magnetic or optical disk, or a magnetic tape.

In this inventions preferred embodiment, the property asset maintenance tool 708 including a housing and where ICD is enclosed within a portion of housing disposed topside of property asset tool directly adjacent bladeset in a fixed position relative to moving blade and defining a flow path for property asset maintenance for capturing images of maintained property asset away in targeted property asset maintenance area using the present invention's proximity sensor 138 software system.

A method for automatic identification of variances in property asset regions, comprising the steps of:

identifying edges from an original image which includes property grass regions; storing a
direction and length of the lines which form each edge; searching a line bundle in which lines of a same direction are gathered; establishing a color of the line bundle as a particular; performing line tracing to identify lines having connections to the line bundle and having the property asset color; and establishing pixels on the identified lines as the property asset region, and applying a superimposed overlay maintenance pattern for property asset preferred state.

The invention provides an improved virtual image viewing and panning system. In this system part of a panoramic 148 image is represented in a detailed image, the location of which is shown in an improved map image visible on a VDD. It is much easier for the user or artificial intelligent system accompanying the autonomously functional property asset maintenance tool to understand direction with trailing directional arrows without any prior knowledge of the physical location of the panoramic 148 image. The detailed image and the map image are never out of sync because any change in the detailed image is immediately reflected in the grid mapping image thereto, and any change in the map image is immediately reflected in the detailed image.

A system and method for displaying 3D 140 data are presented. The method involves transforming a 2D image converting image into a 3D display for maintaining property asset preferred state with the 3D display region divided into two or more display subregions, and assigning a set of display rules to each display subregion.

A substrate sensor system, comprising an optical sensor housed within the invention that uses a processor to separate the property asset from the surrounding paved areas or such property assets as a tree base area indicating the distance distinctly measured between the two objects; reporting to invention system aligned with preferred property asset guide for improved property asset maintenance.

A method of digital image processing using face detection for achieving a desired spatial parameter, comprising: (a) identifying a group of pixels that correspond to a property asset within a main digital image; (b) generating in-camera, capturing or otherwise obtaining

in-camera a collection of one or more images including rendering property asset viewed on VDD or stored in artificially intelligent processing engine within an autonomously operated property asset maintenance tool; (c) tracking property asset within collection of one or more captured images using ICD; (d) identifying one or more sub-groups of pixels that correspond to one or more property asset features of the targeted maintenance area, identifying of group or sub-groups of pixels, or both, being based on the tracking of the property asset within collection of one or more images; (e) determining initial values of one or more parameters of pixels of the one or more sub-groups of pixels; (f) determining an initial spatial parameter of the property asset within the main digital image based on the initial values; (g) determining adjusted values of pixels within the digital image for adjusting the main digital image based on a comparison of the initial and desired spatial parameters; (h) generating an adjusted version of the digital image including adjusted values of pixels; (i) storing, displacing, transmitting, transferring, printing, uploading or downloading the adjusted version of the digital image, or a further processed version, or combinations thereof, and 0) automatically retrieving stored property asset maintenance profile from storage memory with last superimposed overlay design for maintainirg property asset populated.

A user may apply a particular angle of axis for the property asset tool relative to the targeted property asset maintenance plane area of the property asset area, either using a substantially corresponding angle to the property asset to be maintained while holding the property asset maintenance tool in either hands by means of rotating the blade assembly to a preferred position, apart as discussed above. One of these positions of the blade assembly is suitable for use in the right hand, and the other position is suitable for use in the left hand when using the hedge or tree limb maintenance tool embodiment of the property asset maintenance tool. A user may use the invention tool to maintain property assets on one side of the property asset with the blade assembly rotated to one position, then rotate the blade assembly to the other position, grasp the property asset with the other hand, then maintain the property asset on the other side of the property asset while using the ICD and VDD for accurate maintenance. In either hand, the property asset maintenance tool's bladeset is positionable at the angle of attack. Regardless of the rotated position of the bladeset, the configuration of the teeth is such that the property asset maintenance tool may be repeatedly passed through the property asset area in an natural tool action without creating sharply defined “swaths” in the property asset, while using image stabilization 116 to control orientation and vibration of ICD such as not to negatively affect the image being transmitted to the VDD.

The present invention relates generally to property asset maintenance devices having a bladeset including a moving blade reciprocating relative to a stationary blade and a drive system fcr powering the bladeset, and more specifically to pole saws, hedge trimmers, lawn edgers, and lawnmowers used for cutting property asset areas. However, those skilled in the art would be aware that the scope of this present invention could also be applied to other areas such as ice sculptures and lawn trimming, snow removal, skin care, property care, property property tools, or the like.

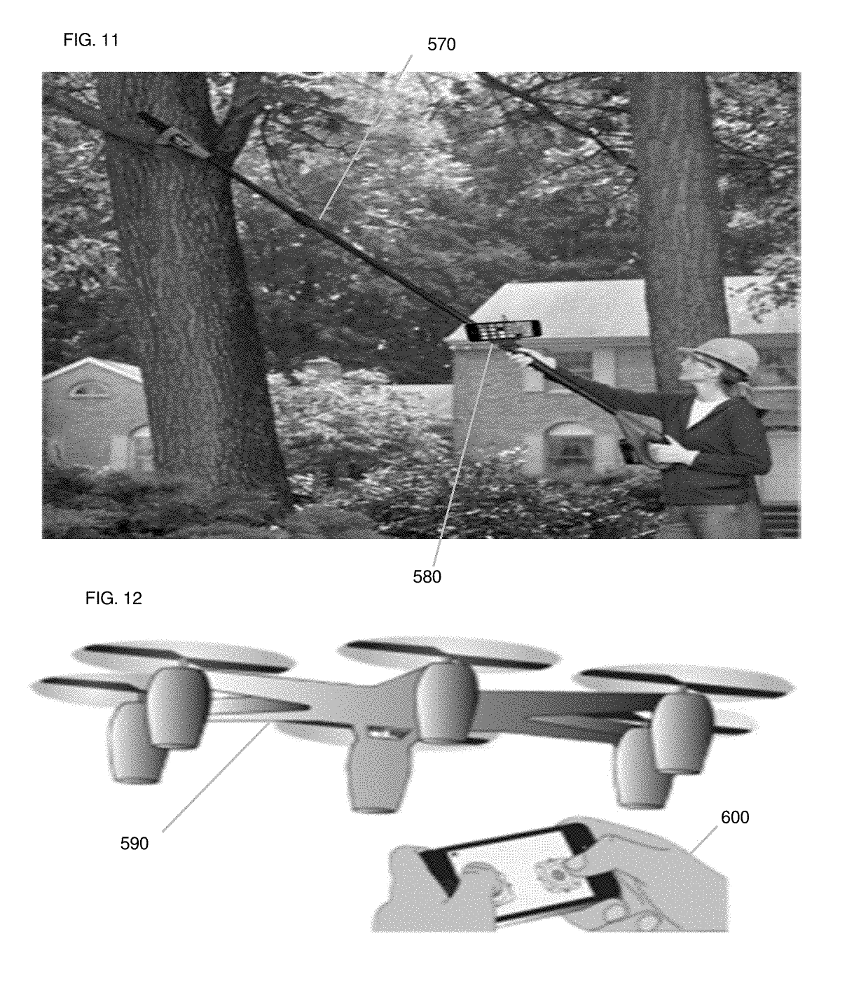

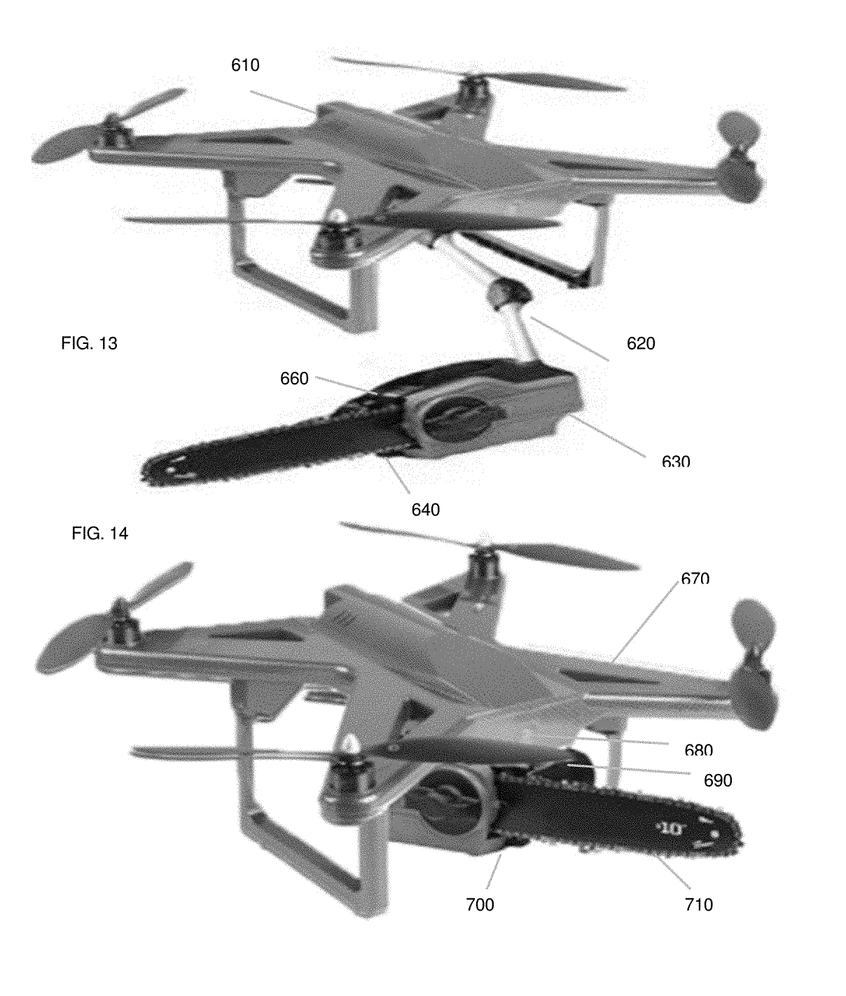

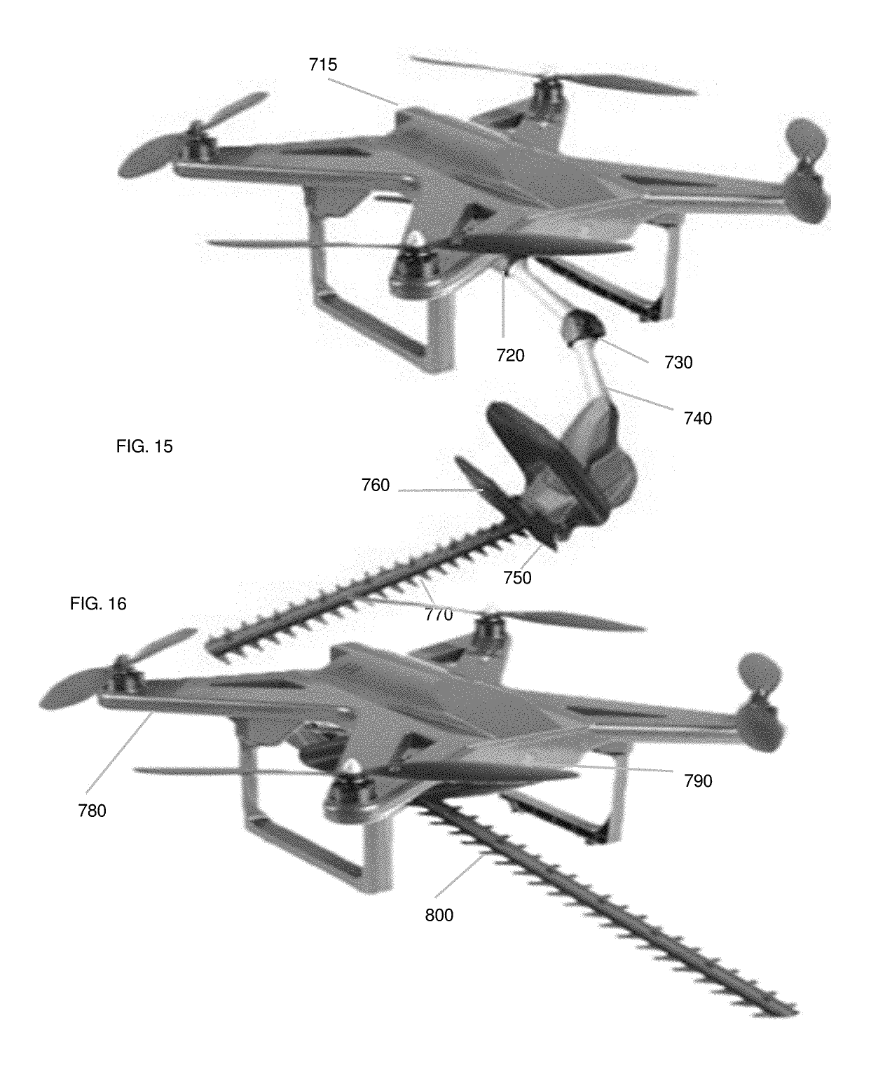

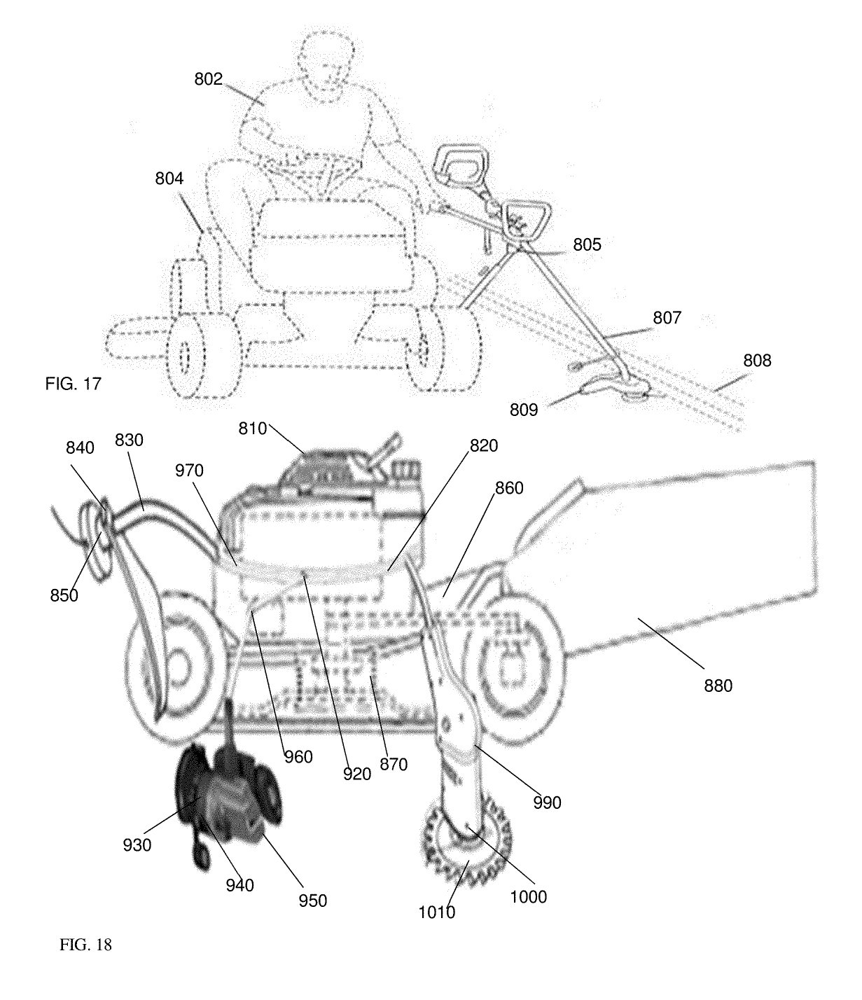

Furthermore, those skilled in the ar will recognize the scope of the present invention can be used with other property asset maintenance tools FIG. 11 such as aerial drones, lawnmowers, hedge trimmers, gutter and downsprout cleaners, property edgers. property vacuums, property leaf blowers 1102,

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A robotic lawnmower comprising:
An autonomous artificial intelligence machine learning system, the system comprising of a least a sensor array and cutting apparatus operating on gas combustion system, solar charging, battery operated, or waste heat energy
A cutting system comprising of an integrated mesh network capable of communicating via restricted secure peer to peer network, cellular, wifi having a smart interactive grass trimmer and grass edger configured to allow user guidance or peer to peer connected mesh networked drones performing scanning feeds
An autonomous lawnmower system in claim 1 comprising a multi unit elevator and garbage canister housing with automatic drone or robotic trash receiver obtaining small bag trash retrieval at owners front door that afterwards the drone robotic apparatus navigates to trash cans and based on designated bag type the multi unit elevator garbage canister housing automatically opens the top lid for drone robot to deposit the designated trash in the trash can
An autonomous robotic lawnmower in claim 1 comprising automatic treatment spraying on weeds, bugs while autonomous mower, self contained grass trimmer or edger performs operational control to maintain property geofenced user drawn property maintenance areas

2. A robotic lawnmower comprising of an integrated trimmer and edger with synched data feeds independently operational based on the location data feeds to the lawnmower comprising a grass trimmer with a smart line feed system

3. A property maintenance apparatus comprising smart autonomous grass trimmer and grass edger operating on an electromagnetic levitational charging rail allowing each smart power tool to navigate 360 degrees without interfering with another tool

4. A power pole cutting apparatus comprising:
A cutting system comprising of a pole saw having a power cord connection, exchangeable battery powered, or gas powered engine with a chain saw bladeset with at least one image camera and sensor; a power pole tool in claim 4 comprising a digital display device such as a users mobile device adhered to an attachment hard wired integrated or wirelessly transmitting images to the display device showing images of the targeted cutting area the user is trying to trim;
A power pole tool in 4 comprising a gutter cleaning system; a pole saw manually operated with each in claim 4 having a camera and display viewing option for easier operation

5. A manual pole saw comprising a blade, elongated shaft, at least one camera and sensor and a user provided mobile device display or integrated display device
A property maintenance apparatus in claim 5 comprising a naturally located handle to grasp linked to a spring that controls the excited cutting movement based on kinetic energy when user pulls on handle to move cutting blade and show the image on the display device

6. A drone comprising a power cutting with at least 1 camera sensor, 1 proximity sensor, 1 power line sensor, pivotal head connecting the power cutting tool by a gimbal using a gyroscope using Context-Aided Sensor Fusion for Enhanced Urban Navigation and inertially stabilized heliostat assembly for balancing and stabilized thru a sight system employing auto collimation of gyro stabilized light beams to maintain balanced flight autonomously operating the power cutting blade; a drone in claim 6 comprising a cutting bladeset and at least one sensor and camera; a camera tracking function in claim 6 comprising an eye tracking system to maintain operational control using eye tracking and voice commands

7. A property maintenance apparatus system comprises:
A power pole apparatus comprising a rotating brush being fed water pressured spraying for cleaning the gutters; a property maintenance method that comprises forced water thru a pipe restricting the pressure causing the force to be multiplied in claim 7; a property maintenance method where a generating power source is enclosed in the housing of the gutter cleaning apparatus thereby thru hydrokinetic energy, the generator powers certain aspects of the property maintenance system such as the flash light
A property maintenance apparatus in claim 7 comprising at least 1 camera and sensor and sends the field of view images in real time to a water proof housing adapter integrated display or user provided mobile device

8. A property maintenance apparatus comprising;
A single serving of wet concentrated or dry yard maintenance pesticide, insecticide, or bug repellant
A property maintenance apparatus in claim 19 comprising dial selector, digital interface flexible circuitry, digital display, cylinder rotational selector, pump action selector, interchangeable cartridge selector pods, water tank hopper mixera pump action or battery operated modulated water streaming like device capable of having prefilled treatment distribution pods attached to the streaming like water like gun device where the treatment pods can be exchanged out singularly or as part of a group mix of different property maintenance treatments
A property maintenance distribution apparatus in claim 19 comprising a computer system having a memory and wireless interface with a laser targeting system, augmented reality visual acuity, image recognition, voice recognition prompt, finger print, retina, pass code security function
A property maintenance treatment apparatus comprising battery powered, pump action, compressed air propellant having a treatment housing comprising of an exchangeable cartridge, a suction cup apparatus container, pneumatic system, with autonomous operation selector
A tire changer comprising:
a rotatable spindle configured to receive a wheel assembly, the wheel assembly comprising at least a rim and a tire;
A wheel assembly service system in accordance with claim 20, wherein the wheel assembly service system is configured as a autonomous tire changer robotic machine.
A rotatable spindle configured to receive a wheel assembly, the wheel assembly comprising at least a rim and a tire; and a controller configured to:
determine a first condition of non-uniformity indicating tire inflation issue of the wheel assembly;
An initiated wireless tire changer autonomous robotic apparatus that disengages of the locking mechanism of the robotic tire changer where the device is housed under the rear or in trunk; and navigation of the same to the issue tire alerted thru a smart alert and monitoring system
A robotic tire changer disengages the autonomous tire chocks and car jack to their respective positions behind the rear tires and under the vehicle h-frame
Robotic tire changer in claim 20 positions itself in front of the issue tire for unlocking the lug nuts; removing the issue tire, and the carriage rotates 180 degrees to position the replacement tire on the lugs using a laser and image targeting proximity sensor array. rotation of the tire with respect to the rim; determine a second non-uniformity of the wheel assembly with the tire rotated with respect to the rim; and determine a non-uniformity component associated with the rim utilizing said first determined non-uniformity and said second determined non-conformity.
